(19) United States
(12) Patent Application Publication
(10) Pub. No.: US 2026/0321713 A1
(43) Pub. Date: Oct. 15, 2026

(54) ORGANIC-INORGANIC COMPOSITE POROUS MEMBRANE FOR ELECTROLYTE AND COMPOSITE ELECTROLYTE HAVING THE SAME

(71) Applicants: DOOSAN CORPORATION, Seoul (KR); IUCF-HYU(Industry-University Cooperation Foundation Hanyang University), Seoul (KR)

(72) Inventors: Yong Wook KIM, Yongin-si (KR); Hyeongjae ROH, Yongin-si (KR); Eunbyoul LEE, Yongin-si (KR); Joohyung LEE, Yongin-si (KR); Dong-Won KIM, Seoul (KR); Ji-Wan KIM, Seongnam-si (KR); Heesu KIM, Ansan-si (KR)

(73) Assignees: DOOSAN CORPORATION, Seoul (KR); IUCF-HYU(Industry-University Cooperation Foundation Hanyang University), Seoul (KR)

(21) Appl. No.: 19/642,082

(22) Filed: Apr. 8, 2026

(30) Foreign Application Priority Data
Apr. 10, 2025 (KR) 10-2025-0046563
Apr. 8, 2026 (KR) 10-2026-0063225

(51) Int. Cl. H01M 10/056; H01M 10/0525

(52) U.S. Cl. CPC H01M 10/056; H01M 10/0525; H01M 2300/0071; H01M 2300/0082; H01M 2300/0085; H01M 2300/0088

(57) ABSTRACT

The present invention relates to an organic-inorganic composite porous membrane for an electrolyte, a composite electrolyte comprising the same, and a secondary battery comprising the composite electrolyte, wherein the organic-inorganic composite porous membrane for an electrolyte includes: a nano-fiber web containing a metal oxide-based nano-fiber; and a binder resin. Accordingly, the organic-inorganic composite porous membrane of the present invention can have excellent ionic conductivity and mechanical strength.

### CROSS-REFERENCE TO RELATED APPLICATION

This application claims priority to and the benefit under 35 U.S.C. § 119 of Korean Patent Application No. 10-2025-0046563, filed on Apr. 10, 2025, and Korean Patent Application No. 10-2026-0063225, filed on Apr. 8, 2026, in the Korean Intellectual Property Office (KIPO), the disclosures of which are incorporated by reference herein in their entirety.

### TECHNICAL FIELD

The present invention relates to an organic-inorganic composite porous membrane for an electrolyte, a composite electrolyte having the same, and a secondary battery having the composite electrolyte.

### BACKGROUND ART

Recently, interest in energy storage technology has been steadily increasing. As the range of applications expands to encompass mobile phones, camcorders, laptop computers, and energy sources for electric vehicles, research and development activities related to batteries are becoming increasingly active and substantive. In this regard, electrochemical devices have attracted the greatest attention, and, in particular, with the recent trend towards the miniaturization and weight reduction of electronic devices, the development of secondary batteries, as rechargeable batteries that are compact, lightweight, and high-capacity, has become a key focus of interest.

As an electrolyte for conventional electrochemical devices, such as batteries utilizing electrochemical reactions and electric double-layer capacitors, a liquid electrolyte, particularly an ion-conducting organic liquid electrolyte in which a salt is dissolved in a non-aqueous organic solvent, has been predominantly used.

However, when the liquid electrolyte is used as described above, there is a significant risk that the electrode material may degrade and the organic solvent may volatilize, and safety concerns may arise, including combustion resulting from an increase in ambient temperature or in the temperature of the battery. In particular, lithium secondary batteries may generate gas inside the battery due to the decomposition of a carbonate organic solvent and/or side reactions between the organic solvent and the electrode during charging and discharging. This gas generation causes the battery thickness to increase, and storage at elevated temperatures accelerates these reactions, resulting in a further increase in gas production.

The gas continuously generated in this manner continuously increases the internal pressure of the battery. This leads not only to deformation of the center portion of a specific surface of the battery, such as swelling of a prismatic battery in a particular direction, but also to local differences in adhesion on the electrode surface within the battery, resulting in non-uniform electrode reactions across the entire electrode surface. Accordingly, a reduction in the performance and safety of the battery is unavoidable.

In order to overcome the safety issues associated with such liquid electrolytes, a gel polymer electrolyte is being used. Such a gel polymer electrolyte exhibits higher ionic conductivity than a solid electrolyte, such as a polymer electrolyte, and can resolve issues including thermal shrinkage of a separator and leakage of an electrolyte solution, thereby improving battery stability while maintaining the performance of a secondary battery, for example a lithium-ion secondary battery. However, the gel polymer electrolyte exhibits lower ionic conductivity than a liquid electrolyte because the ionic conductivity of the gel polymer remains low, even when combined with the liquid electrolyte. In addition, since the gel polymer electrolyte has lower mechanical strength compared to the solid electrolyte, a separator must be used to prevent a short circuit between a positive electrode and a negative electrode. The use of such a separator had a problem of increasing the internal resistance of the battery, resulting in the reduced energy density of the battery.

### SUMMARY

The present invention aims to provide an organic-inorganic composite porous membrane having excellent ionic conductivity and mechanical strength.

In addition, the present invention aims to provide a composite electrolyte having the above-described organic-inorganic composite porous membrane.

Furthermore, the present invention aims to provide a secondary battery having the above-described composite electrolyte.

In order to achieve the above technical problem, the present invention provides an organic-inorganic composite porous membrane for an electrolyte comprising: a nano-fiber web containing a metal oxide-based nano-fiber; and a binder resin.

In one embodiment, the nano-fiber web and the binder resin may be included in a weight ratio of 50:50 to 95:5.

In another embodiment, the metal oxide-based nano-fiber may have a thickness (diameter) of 50 nm to 3 μm.

In another embodiment, the metal oxide-based nano-fiber may include at least one selected from the group consisting of a lithium-containing metal oxide and a non-lithium-containing metal oxide.

In another embodiment, the metal oxide-based nano-fiber may include at least one metal oxide selected from Li₇₋₃ₓLa₃Zr₂AlₓO₁₂ (0<x<0.5) (LLZAO), Li_{1+x+y}AlₓTi₂₋ₓSi_{y}P_{3-y}O₁₂ (0<x<2, 0≤y<3), BaTiO₃, Pb(Zr,Ti)O₃ (PZT), Pb₁₋ₓLaₓZr_{1-y}Ti_{y}O₃ (0≤x<1, 0≤y<1) (PLZT), PB(Mg₃Nb_{2/3})O₃PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ (0<x<2, 0<y<3), LiₓAl_{y}Tiz(PO₄)₃ (0<x<2, 0<y<1, 0<z<3), Li_{1+x+y}(Al, Ga)ₓ(Ti, Ge)₂₋ₓSi_{y}P_{3-y}O₁₂ (0≤x<1, 0≤y≤1), LiₓLa_{y}TiO₃ (0<x<2, 0<y<3), Li₂O, LiOH, Li₂CO₃, LiAlO₂, Li₂O—Al₂O₃—SiO₂—P₂O₅—TiO₂—GeO₂, and Li₃₊ₓLa₃M₂O₁₂ (where M is Te, Nb, or Zr, and 1≤x≤10).

For example, in one embodiment of the present invention, the binder resin may include at least one selected from the group consisting of polyvinylidene fluoride-hexafluoropropylene (PVDF-HFP), polyvinylidene fluoride (PVDF), polyvinyl alcohol (PVA), polymethyl methacrylate (PMMA), and polyacrylonitrile (PAN).

In addition, the present invention provides a composite electrolyte comprising: the above-described organic-inorganic composite porous membrane; and a gel polymer electrolyte part impregnated into the organic-inorganic composite porous membrane.

In one embodiment, the gel polymer electrolyte part may include a polymer matrix, and an electrolyte solution impregnated into the polymer matrix and containing a non-aqueous solvent and a lithium salt.

In addition, the present invention provides a secondary battery comprising the above-described composite electrolyte.

In addition, the present invention provides a method for manufacturing a composite electrolyte, comprising the steps of: forming a nano-fiber web containing a metal oxide-based nano-fiber; preparing a membrane-forming composition comprising the nano-fiber web, a binder resin, a first solvent, and a second solvent having a higher boiling point than the first solvent; applying the membrane-forming composition onto a substrate and drying the composition to form a composition membrane; vacuum drying the composition membrane to form the organic-inorganic composite porous membrane; impregnating a gel polymer electrolyte composition into the organic-inorganic composite porous membrane; and heat-treating the organic-inorganic composite porous membrane impregnated with the gel polymer electrolyte composition.

In one embodiment, the step of forming the nano-fiber web may include the steps of: randomly arranging and accumulating composite nano-fibers, while forming the composite nano-fibers containing one or more metal salts and a polymer by electro-spinning a spinning composition comprising one or more metal salt precursors, the polymer, and a third solvent to form a composite nano-fiber web; and removing the polymer from the composite nano-fiber web by sintering the composite nano-fiber web.

In another embodiment, the one or more metal salt precursors may include at least one selected from a lithium-containing precursor and a non-lithium-containing metal precursor.

In another embodiment, the polymer may include one selected from polyvinylpyrrolidone, polyvinyl alcohol, polyacrylic acid, polymethacrylic acid, polyethylene oxide, polyvinyl acetate, and polyacrylonitrile.

In another embodiment, the spinning composition may include the one or more metal salt precursors and the polymer in a weight ratio of 1:1 to 5:1.

In another embodiment, the electro-spinning may be performed under the following conditions (i) to (iii):
(i) an applied voltage is in a range of 10 to 20 kV, and specifically may be in a range of 12 to 18 kV;
(ii) a spinning flow rate of the spinning composition is in a range of 0.1 to 1 ml/hr, and specifically may be in a range of 0.2 to 0.8 ml/hr; and
(iii) a Tip to Collector Distance (TCD) may be in a range of 10 to 30 cm, and specifically in a range of 10 to 20 cm.

In another embodiment, the sintering step may be performed by heat treatment at a temperature of 700 to 800° C. for five to seven hours.

In another embodiment, the gel polymer electrolyte composition may include: an electrolyte solution containing a non-aqueous solvent and a lithium salt; a polymerizable monomer; and a polymerization initiator.

In another embodiment, the polymerizable monomer may include a polymerizable monomer containing two or more (meth)acrylate groups.

In another embodiment, the heat treatment step may be performed at a temperature of 60 to 80° C. for one to three hours.

An organic-inorganic composite porous membrane according to the present invention can have excellent ionic conductivity and mechanical strength by including a web of metal oxide-based nano-fibers.

In addition, a composite electrolyte according to the present invention includes the above-described organic-inorganic composite porous membrane, thereby having excellent ionic conductivity and mechanical strength, and enabling improvement of the energy density of a battery by omitting the use of a separator. Furthermore, the composite electrolyte according to the present invention exhibits excellent electrochemical stability, thermal stability, and flame retardancy, thereby improving battery cycle life and safety.

### BRIEF DESCRIPTION OF DRAWINGS

FIG. 1 is a schematic cross-sectional view illustrating an organic-inorganic composite porous membrane according to a first embodiment of the present invention.

FIG. 2 is a schematic cross-sectional view illustrating a composite electrolyte according to a second embodiment of the present invention.

FIG. 3 is a schematic cross-sectional view illustrating a secondary battery according to a third embodiment of the present invention.

FIG. 4 is a high resolution scanning electron microscope (HR-SEM) image illustrating the microstructure of a nano-fiber web obtained in Embodiment 1-1.

FIG. 5 is an HR-SEM image and an energy dispersive X-ray spectroscopy (EDX) image illustrating the microstructure of an organic-inorganic composite porous membrane obtained in Embodiment 1-2.

FIG. 6 is an HR-SEM image and an EDX image illustrating the microstructure of an organic-inorganic composite porous membrane obtained in Comparative Example 3-1.

(a) of FIG. 7 is a graph showing ionic conductivity according to changes in the content of LLZAO nano-fibers in an organic-inorganic composite porous membrane, and (b) and (c) of FIG. 7 are images showing mechanical strength according to the change in content.

FIG. 8 is a graph showing light transmittances for the composite electrolyte of Embodiment 1-3 after polymerization (PHM-GPE after polymerization), the organic-inorganic composite porous membrane (PHM) obtained in Embodiment 1-2, and the composite electrolyte of Embodiment 1-3 before and after polymerization (PHM-GPE before polymerization).

(a) to (c) of FIG. 9 are SEM and EDX images of the organic-inorganic composite porous membrane prepared in Embodiment 1-2, and (d) to (f) of FIG. 9 are SEM and EDX images of the composite electrolyte prepared in Embodiment 1-3.

FIG. 10 is an XRD graph of the composite electrolyte obtained in Embodiment 1-3, the organic-inorganic composite porous membrane (PHM) obtained in Embodiment 1-2, the web of LLZAO nano-fibers (LLZAO-NF) obtained in Embodiment 1-1, and cubic garnet Li₅La₃Nb₂O₁₂ (PDF #45-0109).

FIG. 11 is a graph illustrating mechanical strength for the composite electrolyte (PHM-GPE) obtained in Embodiment 1-3, a polyethylene separator (PE), a polyethylene separator impregnated with a gel polymer electrolyte (PE-GPE), and the organic-inorganic composite porous membrane (PHM) Embodiment in Example 1-2.

FIG. 12 is a graph illustrating hardness for the composite electrolyte (PHM-GPE) obtained in Embodiment 1-3, a polyethylene separator (PE), a polyethylene separator impregnated with a gel polymer electrolyte (PE-GPE), and the organic-inorganic composite porous membrane (PHM) obtained in Embodiment 1-2.

FIG. 13 is a TGA graph of the composite electrolyte obtained in Embodiment 1-3 and a polyethylene separator impregnated with a gel polymer electrolyte (PE-GPE).

FIG. 14 is an image showing changes in the appearance of the composite electrolyte obtained in Embodiment 1-3 and a polyethylene separator impregnated with a gel polymer electrolyte (PE-GPE) after high-temperature storage.

(a) of FIG. 15 is a graph illustrating ionic conductivity of each electrolyte at 25° C., and (b) of FIG. 15 is a graph illustrating ionic conductivity of each electrolyte by temperature.

FIG. 16 is a linear sweep voltammetry curve of the composite electrolyte prepared in Embodiment 1-3, a liquid electrolyte of Comparative Example 1-1, and a gel polymer electrolyte of Comparative Example 2-1.

(a) of FIG. 17 is a graph showing the results of AC impedance measurements taken before and after application of a potentiostatic method to a lithium|lithium battery manufactured using each electrolyte, and (b) of FIG. 17 is a graph showing the results obtained when the potentiostatic method is applied with each electrolyte.

FIG. 18 illustrates charge-discharge curves and discharge capacity as a function of cycle number for a coin-type lithium-ion secondary battery of Embodiment 1-4 at room temperature (25° C.).

FIG. 19 illustrates discharge capacities as a function of cycle number for coin-type lithium-ion secondary batteries of Embodiment 1-4, Comparative Example 1-2, and Comparative Example 2-2 at room temperature (25° C.).

FIG. 20 is a graph illustrating charge-discharge curves and discharge capacity as a function of cycle number for the coin-type lithium-ion secondary battery of Embodiment 1-4 at a high temperature (about 55° C.).

FIG. 21 is a graph illustrating discharge capacities as a function of cycle number for the coin-type lithium-ion secondary batteries of Embodiment 1-4, Comparative Example 1-2, and Comparative Example 2-2 at a high temperature (about 55° C.).

FIG. 22 is a graph showing changes in discharge capacity according to the rate performance of the secondary battery of Embodiment 1-4 and a secondary battery of Comparative Example 1-2.

FIG. 23 is a graph showing changes in open-circuit voltage during ultra-high-temperature storage of the secondary battery of Embodiment 1-4, the secondary battery of Comparative Example 1-2, and the secondary battery of Comparative Example 2-2.

FIG. 24 is a graph illustrating a nano-indentation evaluation of the secondary battery of Embodiment 1-4, the secondary battery of Comparative Example 1-2, and the secondary battery of Comparative Example 2-2.

FIG. 25 is a ^{7Li} NMR analysis graph for the composite electrolyte manufactured in Embodiment 1-3 before and after operation of a ^{6Li}∥6Li battery to which the composite electrolyte manufactured in Embodiment 1-3 is applied.

FIG. 26 is a graph showing changes in internal resistance according to charge/discharge cycles of the secondary battery of Embodiment 1-4, the secondary battery of Comparative Example 1-2, and the secondary battery of Comparative Example 2-2.

FIG. 27 is an image illustrating ignition states of the composite electrolyte of Embodiment 1-3, a polyethylene separator impregnated with the liquid electrolyte of Comparative Example 1-1, and a polyethylene separator impregnated with the gel polymer electrolyte of Comparative Example 2-1 and thermally cured.

### REFERENCE NUMERALS

10: Organic-inorganic composite porous membrane,
11a: Metal oxide-based nano-fiber,
11: Nano-fiber web,
12: Binder resin,
20: Gel polymer electrolyte part,
100: Composite electrolyte,
200: Positive electrode,
300: Negative electrode

### DETAILED DESCRIPTION

Hereinafter, the present invention will be described in detail.

Unless otherwise defined, all terms (including technical and scientific terms) used herein have the same meaning as commonly understood by one of ordinary skill in the art to which the present invention belongs. Also, terms such as those defined in commonly used dictionaries are not to be interpreted in an idealized or overly formal sense unless expressly so defined herein.

In addition, sizes and thicknesses of respective components shown in the drawings are arbitrarily shown for convenience of description, and thus the present invention is not necessarily limited to those shown. In the drawings, thicknesses of layers and regions are exaggerated for clarity. In the drawings, the thicknesses of some layers and regions are exaggerated for convenience of explanation.

Throughout this specification, when a part is referred to as “including” a component, it should be understood as an open-ended term implying the possibility of further including other components, rather than excluding other components, unless otherwise stated.

In addition, terms such as “first” and “second” used herein do not indicate any order or importance, but are used to distinguish components from each other.

Since the present invention can be variously modified and have various forms, specific embodiments will be illustrated and described in detail below. However, this is not intended to limit the present invention to specific disclosed forms, and should be understood to include all modifications, equivalents, or substitutes included in the spirit and technical scope of the present invention.

### <Organic-Inorganic Composite Porous Membrane and Method for Manufacturing Same>

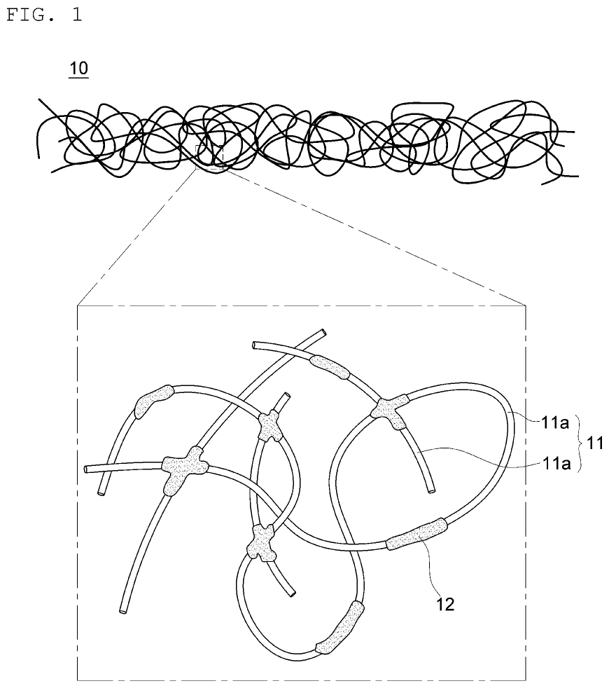

FIG. 1 is a schematic cross-sectional view showing an organic-inorganic composite porous membrane according to a first embodiment of the present invention.

As shown in FIG. 1, the organic-inorganic composite porous membrane 10 of the present invention can be used as a solid electrolyte for a secondary battery, and includes a nano-fiber web 11; and a binder resin 12.

The nano-fiber web 11 is a porous nanostructure containing metal oxide-based nano-fibers 11a. Specifically, the nano-fiber web 11 may have a porous sheet shape formed by randomly arranging and aggregating the metal oxide-based nano-fibers 11a. The metal oxide-based nano-fibers 11a are inorganic nano-fibers containing a metal oxide-based component and are not in powder form, but instead are continuous long fibers (filament fibers) extending in the longitudinal direction. Such continuous metal oxide-based nano-fiber(s) 11a are randomly arranged, as shown in FIG. 1. At this time, the nano-fibers themselves are entangled or the nano-fibers are accumulated in an entangled state, and some of the nano-fibers are fused to each other. The nano-fiber web 11 may not only have a three-dimensional network structure, but may also be a porous fiber assembly having pores existing in gaps between the nano-fibers. In addition, pores may be present on a portion of the surface of the metal oxide-based nano-fiber. As described above, since the nano-fiber web 11 has high porosity and a large specific surface area, both the organic-inorganic composite porous membrane of the present invention and a composite electrolyte can achieve high ionic conductivity and reduced interfacial resistance.

The metal oxide-based nano-fiber 11a of the present invention is a type of inorganic nano-fiber and may include one or more metal oxides, such as a single metal oxide, a solid solution of two or more metal oxides, a mixed phase of two or more phase-separated metal oxide phases, or a compound composed of two or more metal oxides.

Specifically, the metal oxide-based nano-fiber 11a may include at least one selected from the group consisting of a lithium-containing metal oxide and a non-lithium-containing metal oxide.

More specifically, the metal oxide-based nano-fiber 11a may include at least one selected from Li₇₋₃ₓLa₃Zr₂AlₓO₁₂ (0<x<0.5) (LLZAO), Li_{1+x+y}AlₓTi₂₋ₓSi_{y}P_{3-y}O₁₂ (0<x<2, 0≤y<3), BaTiO₃, Pb(Zr,Ti)O₃ (PZT), Pb₁₋ₓLaₓZr_{1-y}Ti_{y}O₃ (0≤x<1, 0≤y<1) (PLZT), PB(Mg₃Nb_{2/3}) O₃PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ (0<x<2, 0<y<3), LiₓAl_{y}Ti_{z}(PO₄)₃ (0<x<2, 0<y<1, 0<z<3), Li_{1+x+y}(Al, Ga)ₓ(Ti, Ge)₂₋ₓSi_{y}P_{3-y}O₁₂ (0≤x≤1, 0≤y≤1), LiₓLa_{y}TiO₃ (0<x<2, 0<y<3), Li₂O, LiOH, Li₂CO₃, LiAlO₂, Li₂O—Al₂O₃—SiO₂—P₂O₅—TiO₂—GeO₂, and Li₃₊ₓLa₃M₂O₁₂ (where M is Te, Nb, or Zr, and 1≤x≤10).

According to an example, the metal oxide-based nano-fiber 11a may include Li₇₋₃ₓLa₃Zr₂AlₓO₁₂ (0<x<0.5) (LLZAO). In this case, the present invention can secure higher ionic conductivity than an organic-inorganic composite porous membrane including a powder-type metal oxide, thereby further enhancing the ionic conductivity of the composite electrolyte.

The thickness (diameter) of the metal oxide-based nano-fiber 11a may be in a range of about 50 nm to 3 μm, specifically about 100 nm to 2 μm, and more specifically 150 nm to 1.9 μm. For reference, the thickness of the metal oxide-based nano-fiber was measured using a high resolution scanning electron microscope (HR-SEM).

The organic-inorganic composite porous membrane 10 of the present invention includes a binder resin 12. The binder resin 12 may be impregnated into a part or all of the nano-fiber web 11, or may coat a part or all of a surface of the nano-fiber web 11, or may coat a part of a surface of the metal oxide-based nano-fiber 11a. The binder resin 12 may be disposed between the metal oxide-based nano-fibers in the nano-fiber web to bond the nano-fibers together. Accordingly, unlike the nano-fiber web that is highly brittle and easily broken even by a small external impact, the organic-inorganic composite porous membrane 10 of the present invention can achieve sufficient strength to withstand external impact without deformation.

The binder resin 12 may include at least one selected from polyvinylidene fluoride-hexafluoropropylene (PVDF-HFP), polyvinylidene fluoride (PVDF), polyvinyl alcohol (PVA), polymethyl methacrylate (PMMA), and polyacrylonitrile (PAN). The binder resin 12 is stable in a lithium-ion battery and can enhance battery stability.

The organic-inorganic composite porous membrane 10 of the present invention may include the nano-fiber web and the binder resin in a weight ratio of 50:50 to 95:5, specifically in a weight ratio of 50:50 to 90:10, more specifically in a weight ratio of 65:35 to 85:15, and even more specifically in a weight ratio of 70:30 to 85:15. According to an example, the organic-inorganic composite porous membrane may include the nano-fiber web and the binder resin in a weight ratio of 75:25 to 83:17.

The above-described organic-inorganic composite porous membrane 10 of the present invention contains a metal oxide component in the form of nano-fibers. Since the organic-inorganic composite porous membrane 10 has higher porosity and a larger specific surface area than when the metal oxide component is present in powder form, it exhibits superior ionic conductivity and mechanical strength and can be used as a solid electrolyte. In addition, the organic-inorganic composite porous membrane 10 of the present invention can be used as a porous support capable of uniformly impregnating a gel polymer electrolyte into internal pores. Because the organic-inorganic composite porous membrane of the present invention maintains its web structure, it can prevent short circuits between the negative and positive electrodes, thereby enhancing battery safety, and can also serve as a solid electrolyte that provides a pathway for lithium ions.

According to an example, the organic-inorganic composite porous membrane 10 of the present invention may have a porosity of about 50 to 60%, specifically about 52 to 57%.

According to another example, the organic-inorganic composite porous membrane 10 of the present invention has a maximum indentation depth of about 6,000 nm under an indentation load of about 10 mN, and has superior mechanical strength, particularly mechanical stiffness, compared with a polyethylene separator having a maximum indentation depth of about 16,500 nm.

According to another example, the organic-inorganic composite porous membrane 10 of the present invention may have a hardness of about 10 to 12 MPa.

The organic-inorganic composite porous membrane 10 of the present invention can be manufactured through a method generally known in the art.

For example, a method for manufacturing the organic-inorganic composite porous membrane 10 of the present invention may include the steps of: (S10) forming a nano-fiber web 11 containing a metal oxide-based nano-fiber 11a; (S20) preparing a membrane-forming composition including the nano-fiber web 11, a binder resin 12, a first solvent, and a second solvent having a higher boiling point than the first solvent; (S30) applying the membrane-forming composition onto a substrate and drying the composition to form a composition membrane; (S40) immersing the composition membrane formed in the step (S30) in an immersion solvent to remove the second solvent; and (S50) vacuum drying the composition membrane obtained in the step (S40) to form the organic-inorganic composite porous membrane 10.

Hereinafter, each step of manufacturing the organic-inorganic composite porous membrane will be described.

### Step (S10): Step for Manufacturing a Nano-Fiber Web

In the step (S10), a nano-fiber web 11 composed of a metal oxide-based nano-fiber 11a may be manufactured through electro-spinning using a spinning solution.

For example, the step (S10) may include the steps of: (S11) randomly arranging and accumulating composite nano-fibers to form a composite nano-fiber web, while forming the composite nano-fibers containing at least one metal salt and a polymer by electro-spinning a spinning composition comprising at least one metal salt precursor, a polymer, and a solvent (hereinafter, referred to as a ‘third solvent’); and (S12) removing the polymer from the composite nano-fiber web by sintering the composite nano-fiber web.

The spinning composition is a spinning solution including at least one metal salt precursor, a polymer, and a third solvent. The spinning composition may be prepared by first forming a polymer-containing solution by dissolving the polymer in the third solvent, and then dissolving at least one metal salt precursor in the polymer-containing solution, or may be obtained by sequentially or simultaneously adding and dissolving at least one metal salt precursor and the polymer in the third solvent.

The at least one metal salt precursor includes at least one selected from a lithium-containing precursor and a non-lithium-containing metal precursor. According to an example, the at least one metal salt precursor may include a lithium-containing precursor and a non-lithium-containing metal precursor. The lithium-containing precursor and the non-lithium-containing metal precursor may be in a molar ratio of 6:5 to 7:5.

The lithium-containing precursor includes a nitrate, a hydroxide, an oxide, a carbonate, an acetate, a chloride, or a hydrate thereof containing lithium, but is not limited thereto. According to an example, the lithium-containing precursor may include lithium nitrate.

The non-lithium-containing metal precursor includes a nitrate, a hydroxide, an oxide, a carbonate, an acetate, a chloride, or a hydrate thereof containing a metal other than lithium, but is not limited thereto. Examples of the metal include an alkali metal, an alkaline earth metal, a lanthanide metal, and a Group 13 to Group 15 metal on the periodic table, and specifically include Na, Mg, Ca, Sr, Ba, Si, Ge, P, Al, Ga, Sn, Pb, Zn, Zr, Ti, Nb, Hf, Ni, Y, La, and Ce, but are not limited thereto. According to an example, the non-lithium-containing metal precursor may include at least one selected from lanthanum nitrate hydrate, zirconium acetate, and aluminum nitrate hydrate.

According to an example, the at least one metal salt precursor may include lithium nitrate, lanthanum nitrate hydrate, zirconium acetate, and aluminum nitrate hydrate. Specifically, lithium nitrate, lanthanum nitrate hydrate, zirconium acetate, and aluminum nitrate hydrate may be in a molar ratio of 30 to 40:10 to 20:5 to 15:1.

If the content of the above-described at least one metal salt precursor is too low, the nano-fiber web may not be properly formed after heat treatment, whereas if it is too high, the viscosity of the spinning composition becomes excessively high, making spinning, particularly electro-spinning, difficult. According to an example, the content of the at least one metal salt precursor may be 10 to 30 wt % based on the total amount of the spinning composition.

The polymer is not particularly limited, provided that it can be easily spun when mixed with the metal salt precursor, forms a fibrous structure during spinning, and controls the structure of the spun fiber. Examples of such a polymer include polyvinylpyrrolidone (PVP), polyvinyl alcohol, polyvinyl acetate, polyethylene oxide, and polyacrylonitrile, which may be used alone or in combination of two or more. For example, the polymer may include polyvinylpyrrolidone.

If the content of such a polymer is too low, a nano-fiber may not be formed, while if it is too high, the viscosity of the spinning composition becomes excessively high, making spinning, particularly electro-spinning, difficult. According to an example, the spinning composition may include the at least one metal salt precursor and the polymer in a weight ratio of 1:1 to 5:1. According to another example, the content of the polymer may be 10 to 35 wt % based on the total amount of the spinning composition. According to another example, the content of the polymer may be about 7 to 20 parts by weight, specifically about 10 to 16 parts by weight, per 100 parts by weight of the polymer-containing solution.

The third solvent is not particularly limited, provided that it can dissolve the polymer and the metal salt precursor, and may include acetic acid, acetone, dimethylformamide (DMF), dimethylacetamide (N,N-dimethylacetamide), and water, which may be used alone or in combinations of two or more. According to an example, the third solvent may be a mixed solvent of acetic acid and water. The mixing ratio of the acetic acid and the water may be in a weight ratio of 10:90 to 30:70.

The content of the third solvent may be adjusted in consideration of the content of the metal salt precursor and the polymer or the viscosity of the spinning composition. According to an example, the content of the third solvent may be a remainder amount adjusted such that the total amount of the spinning composition is 100 wt %, and may specifically be about 50 to 80 wt % based on the total amount of the spinning composition. According to another example, the content of the third solvent may be about 80 to 93 parts by weight, specifically about 84 to 90 parts by weight, per 100 parts by weight of the polymer-containing solution.

The above-described spinning composition may be spun through an electro-spinning method. The electro-spinning method is a spinning technique capable of implementing continuous fibers with diameters ranging from several μm to several nm using an electric field, and allows easy control of the diameter, porosity, and structure of nano-fibers.

For such electro-spinning, an electro-spinning apparatus generally known in the art may be used. The electro-spinning apparatus may include a barrel for storing the spinning composition, a metering pump for discharging the spinning composition at a constant rate, a spinning nozzle for discharging the spinning composition by being fiberized under a high voltage, a power supply for applying the high voltage to the spinning nozzle, and a collector for collecting the fibers.

The electro-spinning may be performed under conditions of (i) an applied voltage in a range of about 10 to 20 kV (specifically, about 12 to 18 kV), (ii) a spinning flow rate of the spinning composition in a range of about 0.1 to 1.0 ml/hr (specifically, about 0.2 to 0.8 ml/hr), and (iii) a Tip to Collector Distance (TCD) in a range of about 10 to 30 cm (specifically, about 10 to 20 cm). According to an example, the electro-spinning may be performed under conditions of an applied voltage of about 13 to 17 kV, a spinning flow rate of the spinning composition in a range of about 0.3 to 0.7 ml/hr, and a TCD in a range of about 12 to 17 cm.

As described above, when the spinning composition is electro-spun, composite nano-fibers formed in which the at least one metal salt and the polymer are mixed, and are simultaneously fused and deposited to form a three-dimensional network structure, thereby obtaining a composite nano-fiber web in which the composite nano-fibers are randomly arranged and accumulated.

The composite nano-fiber web is a porous web composed of composite nano-fibers, and is an ultra-thin film that is ultra-lightweight, has a large specific surface area, and exhibits high porosity. The composite nano-fiber may be a nano-fiber composite in which at least one metal salt and a polymer are mixed. According to an example, the composite nano-fiber may be a polymer-nitrate composite.

The composite nano-fiber web obtained in the step (S11) is sintered. Accordingly, the polymer component of the composite nano-fiber in the composite nano-fiber web is thermally decomposed and removed, while the metal salt component is simultaneously heat-treated in an oxygen-containing atmosphere to form a metal oxide, thereby yielding a nano-fiber web 11 containing a metal oxide-based nano-fiber 11a. The nano-fiber web 11 is a porous web composed only of an inorganic component. Pores formed by removing the polymer present in the composite nano-fiber may remain on portions of the surface of each metal oxide-based nano-fiber 11a. In this case, since the porosity of the nano-fiber web is higher, ionic conductivity can be further improved.

The sintering may be performed by heat treatment at a temperature of about 600 to 900° C. for about five to seven hours.

### Step (S20): Step for Preparing a Membrane-Forming Composition

A membrane-forming composition comprising the nano-fiber web 11 obtained in the step (S10), a binder resin 12, a solvent (hereinafter, referred to as a ‘first solvent’), and a second solvent having a higher boiling point than the first solvent is formed.

Descriptions of the metal oxide-based nano-fiber 11a, the nano-fiber web 11 containing the same, and the binder resin 12 are omitted because they are identical to those respectively described in the above-described organic-inorganic composite porous membrane section.

The content of the nano-fiber web 11 may be about 65 to 90 wt % based on the total amount of the membrane-forming composition.

The content of the binder resin 12 may be about 10 to 35 wt % based on the total amount of the membrane-forming composition.

The first solvent is not particularly limited, provided that it can dissolve the binder resin. Examples of the first solvent include acetone, dimethylformamide (DMF), toluene, tetrahydrofuran (THF), dimethyl sulfoxide, dimethylacetamide, N-methylpyrrolidone (NMP), chloroform, methylene chloride, carbon tetrachloride, trichlorobenzene, benzene, cresol, xylene, methyl ethyl ketone, acrylonitrile, cyclohexane, cyclohexanone, ethyl ether, hexane, isopropyl alcohol, methanol, and ethanol, which may be used alone or in a mixture of two or more thereof.

The content of the first solvent may be about 50 to 90 wt % based on the total amount of the membrane-forming composition.

The membrane-forming composition includes a solvent (hereinafter, referred to as a ‘second solvent’) that is different from the first solvent and has a higher boiling point than the first solvent. According to an example, the second solvent may be a solvent having a high boiling point and low vapor pressure. The second solvent is a type of residual solvent-type additive, and has a characteristic of remaining inside the membrane without volatilizing even during high-temperature and vacuum drying processes. The second solvent is subsequently removed through a separate solvent extraction process to form micro-pores inside the membrane, thereby enabling formation of a porous structure.

The second solvent includes di-butyl phthalate (DBP), di-2-ethylhexyl phthalate (DOP), di-isononyl phthalate (DINP), di-isodecyl phthalate (DIDP), and butyl benzyl phthalate (BBP), but is not limited thereto.

The content of the second solvent is not particularly limited, and may be about 0.001 to 10 wt %, specifically about 0.01 to 5 wt %, and more specifically about 0.01 to 1 wt % based on the total amount of the membrane-forming composition.

### Step (S30): Step for Formation a Composition Membrane

The membrane-forming composition obtained in the step (S20) is applied onto a substrate and dried.

The application method of the membrane-forming composition is not particularly limited, provided that it is capable of forming a porous membrane, and may include casting.

Thereafter, the drying temperature is not particularly limited, provided that it is sufficient to remove the first solvent while preventing removal of the second solvent.

Through this step, a coating film comprising a composition including a nano-fiber web composed of a metal oxide-based nano-fiber and a binder resin can be obtained. The binder resin 12 may be disposed between some or all of the metal oxide-based nano-fibers 11a in the nano-fiber web 11, and/or may be applied so as to coat part or the entire surface of the metal oxide-based nano-fibers 11a. The binder resin 12 may be cured in the step (S40) to more firmly bond the metal oxide-based nano-fibers together.

### Step (S40): Step for Removing the Second Solvent Remaining in the Formed Composition Membrane

The composition membrane formed in the (S30) may be immersed in an immersion solvent to remove the second solvent (residual solvent-type additive) remaining in the composition membrane.

The immersion solvent is an extraction solvent capable of removing the remaining second solvent, and is not particularly limited, provided that it is a solvent that does not dissolve the binder resin. The immersion solvent includes an alcohol, and specifically includes a monohydric alcohol including methanol, ethanol, propanol, butanol, pentanol, and hexadecanol; and a polyhydric alcohol including ethane-1,2-diol, propane-1,2-diol, propane-1,2,3-triol, butane-1,3-diol, butane-1,2,3,4-tetraol, pentane-1,2,3,4,5-pentol, hexane-1,2,3,4,5,6-hexol, and heptane-1,2,3,4,5,6,7-heptol, which may be used alone or in a mixture of two or more thereof.

The immersion time is not particularly limited and may be about one to five hours, specifically about two to four hours.

### Step (S50): Step for Vacuum Drying the Composition Membrane

The composition membrane from which the second solvent is removed in the (S40) may be vacuum-dried to form the organic-inorganic composite porous membrane 10.

In this step, when the composition membrane is vacuum-dried, the solvent used in the immersion step is completely dried to form the organic-inorganic composite porous membrane 10.

The vacuum drying temperature may be adjusted according to the used immersion solvent, and may be about 60 to 100° C., specifically about 60 to 80° C.

### <Composite Electrolyte and Method for Manufacturing Same>

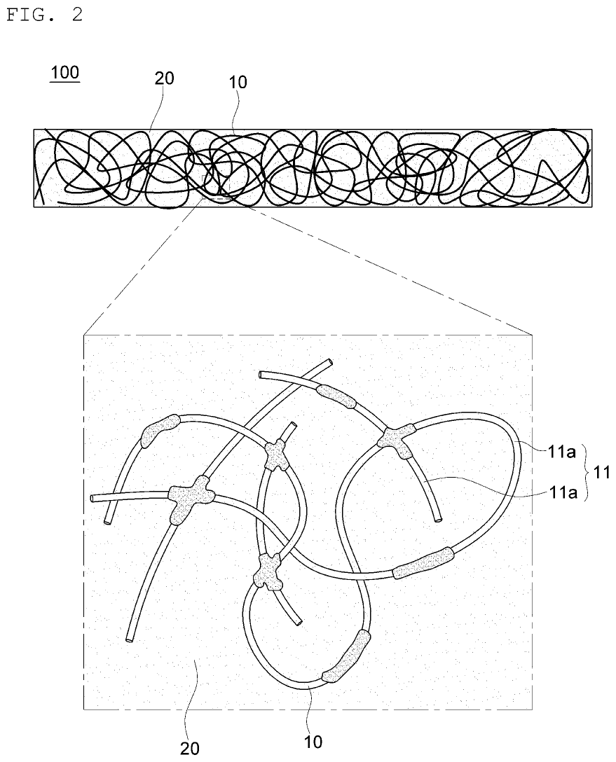

FIG. 2 is a schematic cross-sectional view illustrating a composite electrolyte according to a second embodiment of the present invention.

As illustrated in FIG. 2, the composite electrolyte 100 of the present invention is a type of semi-solid hybrid electrolyte, in which a solid electrolyte and a gel polymer electrolyte are mixed.

According to an example, the composite electrolyte 100 of the present invention includes the above-described organic-inorganic composite porous membrane 10; and a gel polymer electrolyte part 20 impregnated into the organic-inorganic composite porous membrane 10.

In general, a gel polymer electrolyte is a semi-solid electrolyte in which a liquid electrolyte is mixed (impregnated) with a gel polymer. Such a gel polymer electrolyte exhibits higher ionic conductivity than a solid electrolyte, such as a polymer electrolyte, and can resolve issues including thermal shrinkage of a separator and leakage of an electrolyte solution, thereby improving battery stability while maintaining the performance of a secondary battery, for example a lithium-ion secondary battery. However, the gel polymer electrolyte exhibits lower ionic conductivity than a liquid electrolyte because the ionic conductivity of the gel polymer remains low, even when combined with the liquid electrolyte. In addition, since the gel polymer electrolyte has lower mechanical strength compared to the solid electrolyte, a separator must be used to prevent a short circuit between a positive electrode and a negative electrode. The use of such a separator has a problem of increasing the internal resistance of the battery, resulting in the reduced energy density of the battery.

Accordingly, in the present invention, by impregnating the gel polymer electrolyte into the organic-inorganic composite porous membrane including the metal oxide-based nano-fiber described above, ionic conductivity and mechanical strength can be further improved compared with a conventional gel polymer electrolyte. In addition, unlike the conventional gel polymer electrolyte, the composite electrolyte 100 of the present invention can eliminate the need for a separator, thereby increasing the energy density of the battery. In addition, the composite electrolyte 100 of the present invention enables higher capacity performance than a liquid electrolyte and exhibits excellent electrochemical stability, thermal stability, and flame retardancy, thereby improving battery cycle-life characteristics and safety.

Specifically, the organic-inorganic composite porous membrane 10 is a support into which the gel polymer electrolyte part 20 is impregnated, and can improve the mechanical strength of the composite electrolyte 100. In addition, since the organic-inorganic composite porous membrane 10 contains the metal oxide-based nano-fiber 11a, it can serve as a solid electrolyte and exhibits higher ionic conductivity and mechanical strength than a powder-type metal oxide-based solid electrolyte. In addition, since the organic-inorganic composite porous membrane 10 can stably maintain a web structure when applied to a battery, it can prevent short circuits between the negative and positive electrodes, thereby improving battery safety.

The organic-inorganic composite porous membrane 10 and the gel polymer electrolyte part 20 may be in a weight ratio of 50:50 to 80:20, specifically 50:50 to 70:30, and more specifically 55:45 to 65:35. According to an example, the organic-inorganic composite porous membrane 10 and the gel polymer electrolyte part 20 may be in a weight ratio of 60:40.

A description of the organic-inorganic composite porous membrane 10 is omitted as it is the same as that provided in the above section describing the organic-inorganic composite porous membrane.

The gel polymer electrolyte part 20 is a semi-solid electrolyte part in which the gel polymer electrolyte composition is impregnated into and gelated within the organic-inorganic composite porous membrane 10 described above.

According to an example, the gel polymer electrolyte part 20 includes a polymer matrix in a gel state, and an electrolyte solution impregnated (immersed) in the polymer matrix.

The polymer matrix is a polymer component constituting the skeleton of the gel polymer electrolyte part 20. The electrolyte solution is impregnated into the polymer matrix, causing the polymer matrix to swell, and the swollen polymer matrix may form a gel phase. Since such a polymer matrix can suppress irreversible reactions between a negative electrode active material and an electrolyte solution, and act as a support maintaining the structure of the active material and the electrode together with the porous membrane during charging and discharging, the charge-discharge characteristics of the battery can be improved. In addition, since the polymer matrix has appropriate crystallinity and polarity, the composite electrolyte of the present invention and the secondary battery to which the composite electrolyte is applied may have improved ionic conductivity.

The polymerizable monomer undergoes a polymerization reaction initiated by a polymerization initiator and is not particularly limited, provided that it can form a polymer with excellent conductivity. According to an example, the polymerizable monomer may include a polymerizable monomer containing two or more (meth)acrylate groups. Here, the (meth)acrylate group is a monovalent functional group derived from an ester of (meth)acrylic acid, and may refer to an acrylate group or a methacrylate group.

Specifically, non-limiting examples of the polymerizable monomer containing two or more (meth)acrylate groups include trimethylolpropane trimethacrylate, di-trimethylolpropane tetraacrylate, ethoxylated trimethylolpropane triacrylate, butanediol diacrylate, tripropylene glycol diacrylate, and trimethylolpropane trimethacrylate, which may be used alone or in a mixture of two or more thereof.

If the content of these polymerizable monomers is too low, gelation may not proceed sufficiently, making it difficult to achieve the properties of a gel polymer electrolyte. On the other hand, if the content is too high, ionic conductivity may decrease, thereby degrading battery performance. According to an example, the content of the polymerizable monomer may be about 3 to 10 parts by weight per 100 parts by weight of the electrolyte solution.

The polymerization initiator is capable of decomposing under heat, for example at about 30 to 100° C., to generate radicals and reacting with a polymerizable monomer through radical polymerization to form a polymer, and includes AIBN [Azobis(iso-butyronitrile)], 2,2-Azobis(2-cyanobutane), 2,2-Azobis(Methylbutyronitrile), AMVN (Azobis dimethyl-Valeronitrile), benzoyl peroxide, acetyl peroxide, dilauryl peroxide, di-tert-butyl peroxide, t-butyl peroxy-2-ethyl-hexanoate, cumyl hydroperoxide, and hydrogen peroxide, but is not limited thereto.

Such a polymerization initiator may be about 1 to 5 parts by weight per 100 parts by weight of the polymerizable monomer.

The electrolyte solution may include a non-aqueous solvent and a lithium salt, and may further include an electrolyte solution additive, if necessary.

The non-aqueous solvent may include at least one selected from the group consisting of a carbonate-based solvent, an ether-based solvent, an ester-based solvent, and a polar functional group-containing solvent. According to an example, the non-aqueous solvent may be a carbonate-based solvent, and specifically may include at least one selected from ethylene carbonate, propylene carbonate, dimethyl carbonate, diethyl carbonate, ethylmethyl carbonate, fluoroethylene carbonate, difluoroethylene carbonate, fluorodimethyl carbonate, and fluoroethylmethyl carbonate. Such a non-aqueous solvent may be used in an amount generally used in the art.

The lithium salt is dissolved in the non-aqueous solvent, and may include at least one selected from the group consisting of LiPF₆, LiBF₄, LiCl, LiBr, LiI, LiClO₄, LiAsF₆, LiCH₃CO₂, LiCF₃SO₃, LiN(CF₃SO₂)₂, and LiC(CF₂SO₂)₃, but is not limited thereto. Such a lithium salt may be used in an amount generally used in the art.

The electrolyte solution additive may include at least one selected from the group consisting of vinylene carbonate (VC), fluoroethylene carbonate (FEC), 1,3-propane sultone (PS), 1,3-propene sultone (PRS), ethylene sulfate (Esa), and trimethylene sulfate (TMS). Such an electrolyte solution additive may be included in an amount of about 1 to 10 wt % based on the total amount of the electrolyte solution.

The composite electrolyte 100 of the present invention can be manufactured by impregnating the gel polymer electrolyte composition into the organic-inorganic composite porous membrane 10 described above, and then polymerizing the gel polymer electrolyte composition.

According to an example, a method for manufacturing the composite electrolyte 100 of the present invention may include the steps of: (S100) forming a nano-fiber web 11 containing a metal oxide-based nano-fiber 11a; (S200) preparing a membrane-forming composition comprising the nano-fiber web 11, a binder resin 12, and a first solvent; (S300) applying the membrane-forming composition onto a substrate and drying the composition to form a composition membrane; (S400) vacuum-drying the composition membrane to form the organic-inorganic composite porous membrane 10; (S500) impregnating a gel polymer electrolyte composition into the organic-inorganic composite porous membrane 10; and (S600) heat-treating the organic-inorganic composite porous membrane impregnated with the gel polymer electrolyte composition.

Hereinafter, each step of manufacturing the composite electrolyte 100 of the present invention will be described.

Descriptions of steps (S100) to (S400) are omitted as they correspond respectively to steps (S10) to (S40) described above in the method for manufacturing the organic-inorganic composite porous membrane.

The gel polymer electrolyte composition is impregnated into the organic-inorganic composite porous membrane manufactured in the step (S400) [i.e., step (S40)].

The organic-inorganic composite porous membrane may be immersed in the gel polymer electrolyte composition. As a result, the gel polymer electrolyte composition may not only penetrate into pores of the organic-inorganic composite porous membrane but may also be present on part or the entire surface of the porous membrane.

The gel polymer electrolyte composition includes an electrolyte solution containing a non-aqueous solvent and a lithium salt; a polymerizable monomer; and a polymerization initiator, and descriptions of each component are omitted as they are identical to those provided in the above section relating to the gel polymer electrolyte part.

The impregnation time is not particularly limited, provided that impregnation sufficiently proceeds and no evaporation of the electrolyte is observed, and may be about five minutes to one hour.

In the step (S500), the organic-inorganic composite porous membrane impregnated with the gel polymer electrolyte composition is heat-treated. A gel polymer electrolyte is formed by the heat treatment. Specifically, the polymerizable monomer and the polymerization initiator under polymerization to form a crosslinked polymer matrix. The electrolyte solution, in which the lithium salt is dissociated into the non-aqueous solvent, is impregnated into the formed polymer matrix, thereby forming the polymer matrix is formed in a gel state. As a result, the gel polymer electrolyte portion is disposed within the pores of the organic-inorganic composite porous membrane and/or on part or the entire surface of the membrane.

The heat treatment step may be performed at a temperature of about 40 to 70° C., specifically about 50 to 60° C., for about one to three hours.

### <Secondary Battery>

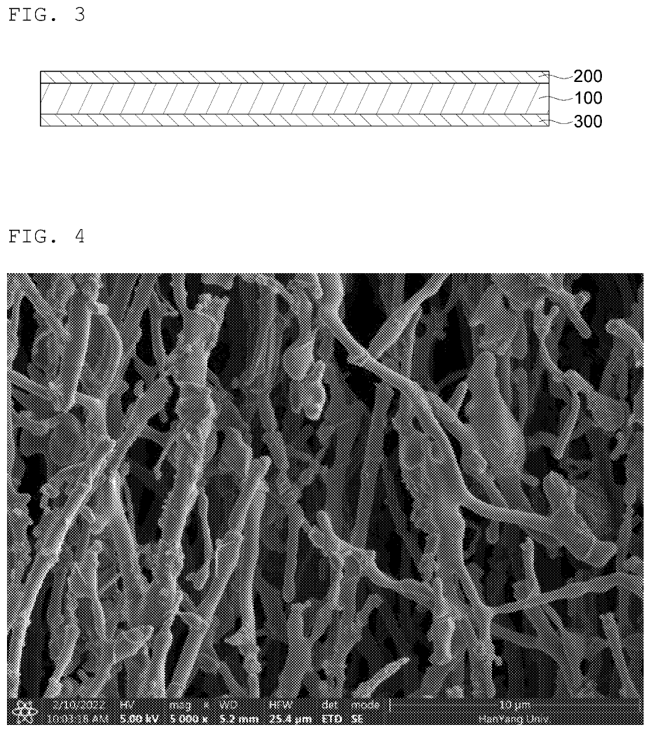

FIG. 3 is a schematic cross-sectional view illustrating a secondary battery according to a third embodiment of the present invention.

As illustrated in FIG. 3, the secondary battery of the present invention includes the composite electrolyte 100 described above. In particular, the secondary battery may be a lithium secondary battery, and more specifically a lithium-ion secondary battery. Since the secondary battery of the present invention includes the composite electrolyte, a separate separator may not be required, thereby reducing manufacturing costs while simultaneously securing excellent electrochemical performance, thermal stability, and long lifespan characteristics.

According to an example, the secondary battery of the present invention may include a positive electrode 200; a negative electrode 300; and a composite electrolyte 100 disposed between the positive electrode and the negative electrode.

The positive electrode 200 may be an electrode that undergoes a reduction reaction during discharging. The negative electrode 300 may be an electrode that undergoes an oxidation reaction during discharging.

An electrode of the battery may include an electrode active material attached to an electrode current collector.

The positive electrode active material is not particularly limited, provided that it is one commonly used in a secondary battery (for example, a lithium-ion secondary battery) in the art. The positive electrode active material may include a lithium-containing transition metal oxide. Specifically, the positive electrode active material may be LiCoO₂, LiNiₓCo_{y}Mn_{z}O₂ (0<x<1, 0<y<1, x+y+z=1), LiNiₓCo_{y}Al_{z}O₂ (0<x<1, 0<y<1, x+y+z=1), LiFePO₄, LiCoPO₄, LiNiO₂, LiMnO₂, LiMn₂O₄, LiMn_{2-z}Ni_{z}O₄ (0<z<2), LiMn_{2-z}Co_{z}O₄ (0<z<2), or a mixture thereof. According to an example, the positive electrode active material may include at least one selected from LiCoO₂, LiNiₓCo_{y}Mn_{z}O₂ (0<x<1, 0<y<1, x+y+z=1), LiNiₓCo_{y}Al_{z}O₂ (0<x<1, 0<y<1, x+y+z=1), and LiFePO₄.

The negative electrode active material is not particularly limited, provided that it is one commonly used in a secondary battery (for example, a lithium-ion secondary battery) in the art. The negative electrode active material may include at least one selected from the group consisting of a lithium-based metal including a lithium metal and a lithium alloy; and a carbon-based compound including carbon, hard carbon, and graphite. According to an example, the negative electrode active material may include graphite.

The positive electrode current collector may be a foil of a metal including at least one selected from the group consisting of aluminum and nickel.

The negative electrode current collector may be a foil of a metal including at least one selected from the group consisting of copper, gold, and nickel.

The electrode described above may be manufactured by a manufacturing method generally known in the art. For example, the electrode may be manufactured by preparing an electrode slurry by mixing an electrode active material, a conductive material, a binder, and a solvent, and then directly coating the electrode slurry onto an electrode current collector, or by laminating an electrode active material film, cast on a separate support and peeled from the support, onto an electrode current collector. As the conductive material, binder, and solvent, materials generally used in the art may be used.

Such a secondary battery may be used as a battery cell serving as a power source for a small device, and may also be used as a unit battery in a medium-to-large battery module including a plurality of battery cells. Examples of the medium-to-large device include an electric vehicle, a hybrid electric vehicle, a plug-in hybrid electric vehicle, and a power storage system, and in particular, it can be usefully used for a hybrid electric vehicle and a battery for storing renewable energy, which are areas requiring high output.

Hereinafter, the present invention will be described in more detail with reference to Embodiments and Comparative Examples. However, the following Embodiments are provided to illustrate the present invention, and the scope of the present invention is not limited thereto.

### Embodiment 1

### 1-1. Preparation of Nano-Fiber Web

Lithium nitrate, lanthanum(III) nitrate hexahydrate, zirconium(IV) acetate, and aluminum nitrate nonahydrate were mixed in a molar ratio of 7.3:3:2:0.2 to obtain a precursor mixture. Meanwhile, a mixed solvent of 1.75 g of acetic acid and 7 g of water was prepared, and then polyvinylpyrrolidone (PVP) was dissolved in the mixed solvent to obtain an aqueous acetic acid solution containing polyvinylpyrrolidone (PVP) (PVP:mixed solvent=13:87 weight ratio). Thereafter, about 5.5 g of the precursor mixture was dissolved in 10 g of the PVP-containing aqueous acetic acid solution to obtain a spinning composition. The spinning composition was electro-spun [spinning flow rate: 0.5 mL/h, applied voltage: 15 kV, TCD (Tip to Collector Distance) 15 cm] to produce a composite nano-fiber that is a composite of polyvinylpyrrolidone-metal nitrate in the form of a nano-fiber, while accumulating the composite nano-fiber on a collector to obtain a composite nano-fiber web. Thereafter, the composite nano-fiber was sintered at a temperature of 750° C. for six hours to obtain a nano-fiber web composed of a nano-fiber of Li₇₋₃ₓLa₃Zr₂AlₓO₁₂ (0<x<0.5) (LLZAO).

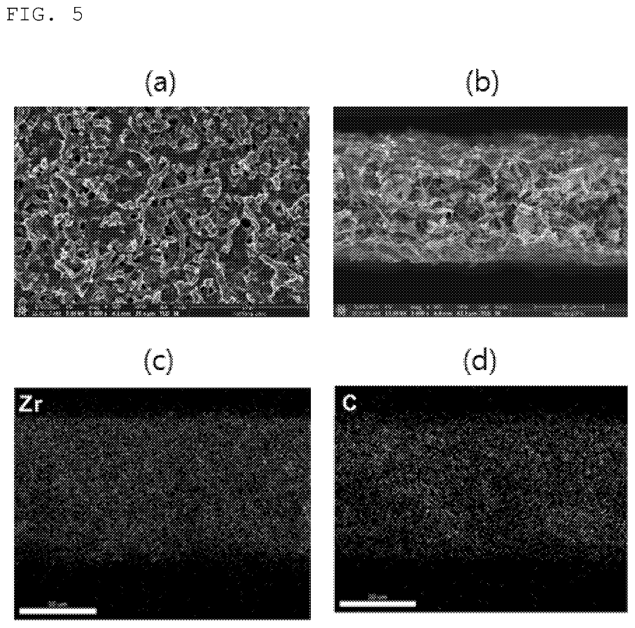

The microstructure of the nano-fiber web obtained above was analyzed using HR-SEM. As a result, as illustrated in FIG. 4, the nano-fiber web is arranged such that a plurality of nano-fibers are randomly crossed, fused, and accumulated. Measurements of several nano-fibers showed thicknesses of approximately 0.5 μm, 0.8 μm, and 1 μm, corresponding to an average nano-fiber thickness of about 800 nm.

### 1-2. Preparation of Organic-Inorganic Composite Porous Membrane Containing Metal Oxide-Based Nano-Fiber

A mixed solvent was prepared by mixing 0.16 g of di-butyl phthalate with 2 g of acetone. Then, 0.4 g of the nano-fiber web obtained in Embodiment 1-1 and 0.1 g of a polyvinylidene fluoride-hexafluoropropylene copolymer (PVDF-co-HFP) were added to the mixed solvent to form a membrane-forming composition. Subsequently, the membrane-forming composition was cast on a flat plate and dried to obtain a composition membrane including the nano-fiber web and the PVDF-co-HFP. Thereafter, the composition membrane was immersed in ethanol for three hours to remove di-butyl phthalate remaining in the porous membrane, and then vacuum-dried at a temperature of 70° C. to manufacture an organic-inorganic composite porous membrane having a thickness of 24 μm (content of LLZAO nano-fiber: 80 wt % based on the total amount of the porous membrane).

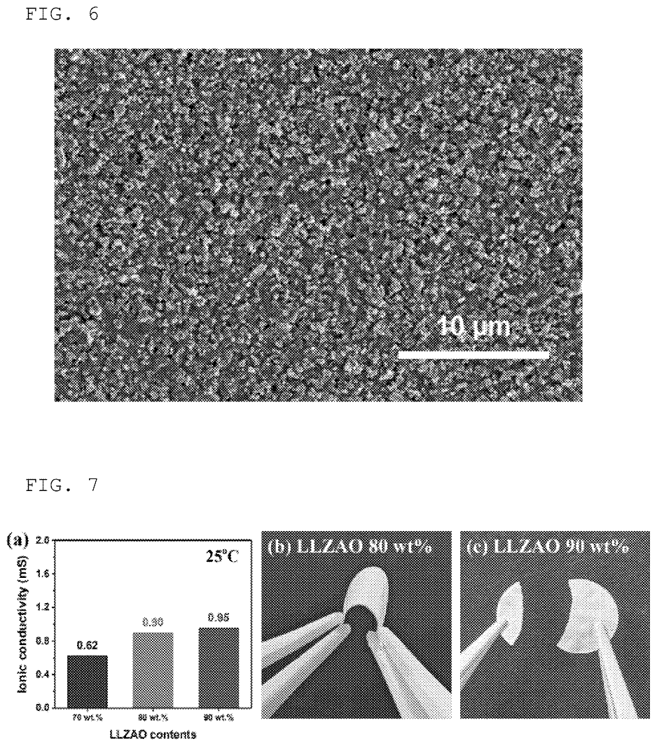

The microstructure of the manufactured organic-inorganic composite porous membrane was analyzed using HR-SEM and EDX. As a result, as illustrated in FIG. 5, the organic-inorganic composite porous membrane contained a plurality of nano-fibers and exhibited a porous structure.

### 1-3. Preparation of Composite Electrolyte

After dissolving lithium hexafluorophosphate (LiPF₆) having a concentration of 1.15 M in a mixed solvent of ethylene carbonate (EC), ethyl methyl carbonate (EMC), and diethyl carbonate (DEC) (EC:EMC:DEC=30:50:20 volume ratio), a liquid electrolyte was prepared by adding 5 wt % of fluoroethylene carbonate (FEC) thereto based on a total amount of the liquid electrolyte. Here, FEC was used as an additive for forming a solid electrolyte interphase (SEI).

Thereafter, 0.4 g of trimethylolpropane trimethacrylate (TMPTMA) as a polymerizable monomer was mixed with 9.6 g of the liquid electrolyte, and 0.003 g of AIBN [azobis(iso-butyronitrile)] as an initiator was additionally added thereto to prepare a gel polymer electrolyte composition (content of the polymerizable monomer=about 4 wt %).

Subsequently, the gel polymer electrolyte composition was impregnated into the organic-inorganic composite porous membrane prepared in Embodiment 1-2, and then heat-treated at a temperature of 70° C. for two hours to prepare a composite electrolyte.

### 1-4. Manufacture of Lithium-Ion Secondary Battery

A negative electrode slurry (negative electrode active material:Super P:binder=95:3:2 weight ratio) was prepared by uniformly dispersing a negative electrode active material graphite, a conductive material Super P, and a binder PVDF in the solvent n-methyl pyrrolidone (NMP). Thereafter, the negative electrode slurry was applied onto one surface of a Cu current collector (thickness: 20 μm), dried, and rolled to manufacture a negative electrode. The areal capacity of the negative electrode was 3.2 mAh/cm².

Meanwhile, a positive electrode slurry (positive electrode active material:Super P:binder=95:3:2 weight ratio) was prepared by uniformly dispersing a positive electrode active material LiNi_{0.8}Co_{0.1}Mn_{0.1}O₂, a conductive material Super P, and a binder PVDF in the solvent NMP. Thereafter, the positive electrode slurry was applied onto one surface of an Al current collector (thickness: 20 μm), dried, and rolled to manufacture a positive electrode. The areal capacity of the positive electrode was 2.8 mAh/cm².

Thereafter, the positive electrode and the negative electrode were disposed such that the positive electrode active material layer of the positive electrode and the negative electrode active material layer of the negative electrode face each other. Subsequently, the composite electrolyte prepared in Embodiment 1-3 was disposed between the positive electrode active material layer and the negative electrode active material layer to prepare an electrode assembly. Here, the electrode assembly did not use a separate separator. Thereafter, the electrode assembly was placed in a coin-type battery case, sealed, and heat-treated at 70° C. for two hours to manufacture a coin-type lithium-ion battery.

### Comparative Example 1

### 1-1. Preparation of Liquid Electrolyte for Lithium-Ion Secondary Battery

After dissolving lithium hexafluorophosphate (LiPF₆) having a concentration of 1.15 M in a mixed solvent of ethylene carbonate (EC), ethyl methyl carbonate (EMC), and diethyl carbonate (DEC) (EC:EMC:DEC=30:50:20 volume ratio), a liquid electrolyte was prepared by adding 5 wt % of fluoroethylene carbonate (FEC) thereto based on the total amount of the liquid electrolyte. Here, FEC was used as an additive for forming a solid electrolyte interphase (SEI).

### 1-2. Manufacture of Coin-Type Lithium-Ion Battery

The positive electrode and the negative electrode were disposed such that the positive electrode active material layer of the positive electrode and the negative electrode active material layer of the negative electrode face each other. The positive electrode and the negative electrode manufactured in Embodiment 1-4 were respectively used. Subsequently, a polyethylene separator was inserted between the positive electrode active material layer and the negative electrode active material layer to prepare an electrode assembly. Thereafter, after placing the electrode assembly in a coin-type battery case, the liquid electrolyte prepared in Comparative Example 1-1 was injected into the battery case to manufacture a coin-type lithium-ion battery.

### Comparative Example 2

### 2-1. Preparation of Gel Polymer Electrolyte

0.4 g of trimethylolpropane trimethacrylate (TMPTMA) as a polymerizable monomer was mixed with 9.6 g of the liquid electrolyte prepared in Comparative Example 1, and 0.003 g of AIBN [azobis(iso-butyronitrile)] as an initiator was additionally added thereto to prepare a gel polymer electrolyte composition (content of the polymerizable monomer: about 4 wt %).

### 2-2. Manufacture of Coin-Type Lithium-Ion Battery

The positive electrode and the negative electrode were disposed such that the positive electrode active material layer of the positive electrode and the negative electrode active material layer of the negative electrode face each other. The positive electrode and the negative electrode manufactured in Embodiment 1-4 were respectively used. Subsequently, a polyethylene separator was inserted between the positive electrode active material layer and the negative electrode active material layer to prepare an electrode assembly. Thereafter, after placing the electrode assembly in a coin-type battery case, the gel polymer electrolyte composition prepared in Comparative Example 2-1 was injected into the battery case, and heat-treated at a temperature of 70° C. for two hours to manufacture a coin-type lithium-ion battery.

### Comparative Example 3

### 3-1. Preparation of Organic-Inorganic Composite Porous Membrane Containing Powder-Type Metal Oxide

An organic-inorganic composite porous membrane (thickness: 25 μm) was prepared in the same manner as in Embodiment 1-2, except that a powder-type metal oxide [L_{6.4}La₃Zr_{1.4}Ta_{0.6}O₁₂ (D50: 500 nm)] was used instead of the nano-fiber web prepared in Embodiment 1-1.

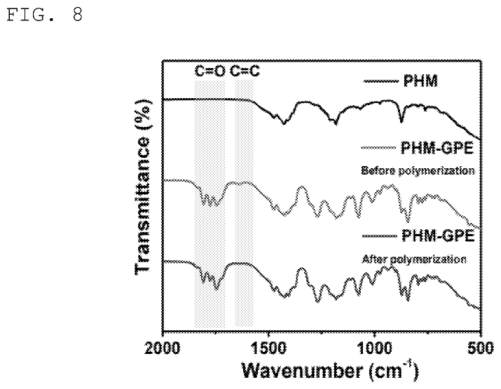

The microstructure of the prepared organic-inorganic composite porous membrane was analyzed using HR-SEM. As a result, as illustrated in FIG. 6, powder-type metal oxide particles were present.

### 3-2. Preparation of Composite Electrolyte

A composite electrolyte was prepared in the same manner as in Embodiment 1-3, except that the organic-inorganic composite porous membrane prepared in Comparative Example 3-1 was used instead of the organic-inorganic composite porous membrane prepared in Embodiment 1-2.

### 3-3. Manufacture of Lithium-Ion Secondary Battery

A coin-type lithium-ion battery was manufactured in the same manner as in Embodiment 1-4, except that the composite electrolyte prepared in Comparative Example 3-2 was used instead of the composite electrolyte prepared in Embodiment 1-3.

### <Experimental Example 1>—Measurement of Ionic Conductivity and Mechanical Strength of Organic-Inorganic Composite Porous Membrane According to Content of Nano-Fiber

The ionic conductivity and mechanical strength of the organic-inorganic composite porous membrane, according to the content of the metal oxide-based nano-fiber contained in the organic-inorganic composite porous membrane of the present invention, were measured as described below, and the results are shown in (a) to (c) of FIG. 7.

### (1) Sample Preparation

An organic-inorganic composite porous membrane was manufactured according to Embodiment 1, and Samples 1 to 3 were prepared by adjusting the content of the LLZAO nano-fiber in the organic-inorganic composite porous membrane to 70 wt %, 80 wt %, and 90 wt %, respectively.

### (2) Measurement of Ionic Conductivity of Organic-Inorganic Composite Porous Membrane

Each sample was placed in a coin-type battery case to manufacture a coin-type symmetric cell, an internal resistance (R) of the manufactured coin-type symmetric cell was measured through an AC-impedance method, and an ionic conductivity (0) was calculated through Equation 1 below. At this time, a CHI-660d was used as the measuring instrument.

$$σ = \frac{L}{R \times A} \qquad [ Equation 1 ]$$

(In the above equation,
L is a thickness of the sample (porous membrane),
R is an internal resistance of the cell, and
A is an effective area in which an electrode and the sample (porous membrane) contact each other.)

### (3) Flexibility Measurement of Organic-Inorganic Composite Porous Membrane

The sample was fully folded and then unfolded in one direction, and it was confirmed whether the sample had fractured.

As a result of the measurements, increasing the content of the LLZAO nano-fiber in the organic-inorganic composite porous membrane led to increases in both ionic conductivity and mechanical strength of the organic-inorganic composite porous membrane. However, in the case of Sample 3, in which the content of the LLZAO nano-fiber in the organic-inorganic composite porous membrane was 90 wt %, the membrane was hard and less flexible and therefore fractured into two pieces.

These results confirm that increasing the content of the metal oxide-based nano-fiber in the organic-inorganic composite porous membrane manufactured according to the present invention enhances both ionic conductivity and mechanical strength; however, flexibility may deteriorate when the nano-fiber content reaches approximately 90 wt % or higher.

### <Experimental Example 2>—Evaluation of Impregnation and Polymerization of the Gel Polymer Electrolyte in the Composite Electrolyte

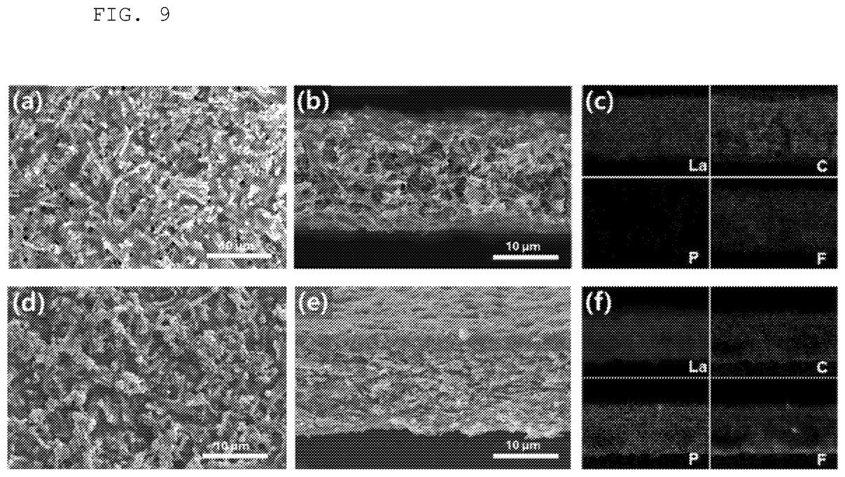

To indirectly confirm impregnation and polymerization of the gel polymer electrolyte in the composite electrolyte of the present invention, infrared spectroscopy (FT-IR) of the composite electrolyte (PHM-GPE after polymerization) of Embodiment 1-3 was conducted as follows, and the results are shown in FIG. 8. The organic-inorganic composite porous membrane (PHM) obtained in Embodiment 1-2 was used as Control Group 1, and the organic-inorganic composite porous membrane (PHM-GPE before polymerization) impregnated with a gel polymer electrolyte composition, which was not thermally cured, in preparing a composite electrolyte according to Embodiment 1-3, was used as Control Group 2.

As a measurement result, unlike the organic-inorganic composite porous membrane (PHM) obtained in Embodiment 1-2, a new peak was observed in the vicinity of about 1700 cm-1 in the organic-inorganic composite porous membrane (PHM-GPE before polymerization) impregnated with the gel polymer electrolyte composition and the composite electrolyte (PHM-GPE after polymerization) of Embodiment 1-3. This confirms that the gel polymer electrolyte was effectively impregnated into the porous membrane. In addition, unlike the organic-inorganic composite porous membrane (PHM-GPE before polymerization) impregnated with the gel polymer electrolyte composition, a C═C peak disappeared in the vicinity of about 1650 cm⁻¹ in the composite electrolyte (PHM-GPE after polymerization) of Embodiment 1-3. This confirms that polymerization smoothly proceeded in the composite electrolyte (PHM-GPE after polymerization) of Embodiment 1-3.

This indirectly confirms that the composite electrolyte of the present invention contains a gel polymer electrolyte.

### <Experimental Example 3>—Microstructure Analysis of Organic-Inorganic Composite Porous Membrane and Composite Electrolyte

In order to analyze microstructures of the organic-inorganic composite porous membrane and the composite electrolyte of the present invention, SEM and EDX analyses were performed on the organic-inorganic composite porous membrane manufactured in Embodiment 1-2 and the composite electrolyte manufactured in Embodiment 1-3; the results are shown in (a) to (f) of FIG. 9.

As illustrated in (a) and (b) of FIG. 9, the organic-inorganic composite porous membrane manufactured in Embodiment 1-2 had a porous structure. In addition, the organic-inorganic composite porous membrane manufactured in Embodiment 1-2 contained the LLZAO nano-fiber (see (c) of FIG. 9).

Meanwhile, as illustrated in (d) and (e) of FIG. 9, the composite electrolyte manufactured in Embodiment 1-3 also had a porous structure. In addition, similar to the organic-inorganic composite porous membrane of Embodiment 1-2, the composite electrolyte manufactured in Embodiment 1-3 contained the LLZAO nano-fiber. However, unlike the organic-inorganic composite porous membrane of Embodiment 1-2, the composite electrolyte manufactured in Embodiment 1-3 had pores filled with a gel polymer electrolyte (see (f) of FIG. 9).

This confirms that the organic-inorganic composite porous membrane of the present invention contains a metal oxide-based nano-fiber and exhibits a porous structure. In addition, it was confirmed that the composite electrolyte of the present invention contains a metal oxide-based nano-fiber, has a porous structure, and includes a gel polymer electrolyte impregnated in pores of the porous structure.

### <Experimental Example 4>—Physical Properties of Composite Electrolyte

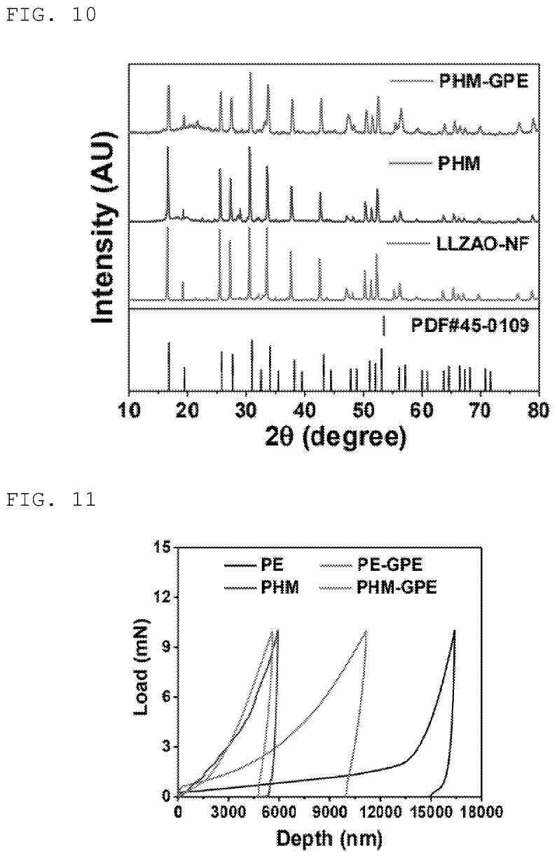

Physical properties of the composite electrolyte according to the present invention were measured as follows, and the results are shown in FIGS. 10 to 12.

### (1) Crystal Structure of Composite Electrolyte

An XRD analysis of the composite electrolyte obtained in Embodiment 1-3 was performed using an X-ray diffractometer (D8 Advance manufactured by Bruker), and the results are shown in FIG. 10. As control groups, the organic-inorganic composite porous membrane (PHM) obtained in Embodiment 1-2, the web of LLZAO nano-fibers (LLZAO-NF) obtained in Embodiment 1-1, and cubic garnet Li₅La₃Nb₂O₁₂ (PDF #45-0109) were used.

The analysis results confirmed that the crystal structure of LLZAO was properly maintained in the composite electrolyte of Embodiment 1-3, similar to the control groups.

### (2) Mechanical Strength (Stiffness)

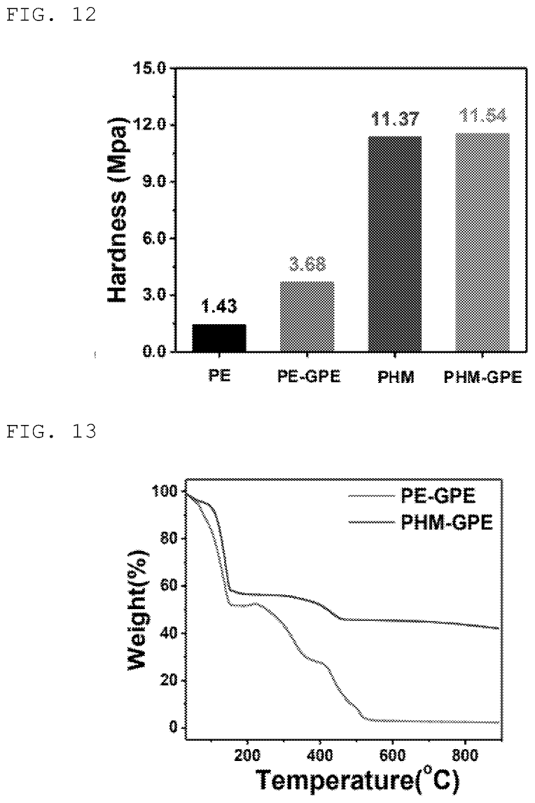

The mechanical stiffness of the composite electrolyte (PHM-GPE) obtained in Embodiment 1-3 was measured using a Nanoindenter (NanoTest Vantage Platform manufactured by MICRO MATERIALS), and the results are shown in FIG. 11. As control groups, a polyethylene separator (PE), a polyethylene separator (PE-GPE) impregnated with a gel polymer electrolyte, and the organic-inorganic composite porous membrane (PHM) obtained in Embodiment 1-2 were respectively used. A component of the GPE in the PE-GPE, that is, the gel polymer electrolyte impregnated in the PE-GPE, was configured identically to Embodiment 1-3.

As a measurement result, both the organic-inorganic composite porous membrane (PHM) of Embodiment 1-2 and the composite electrolyte (PHM-GPE) of Embodiment 1-3 had more excellent mechanical strength than the polyethylene separator (PE) and the polyethylene separator (PE-GPE) impregnated with a gel polymer electrolyte. In particular, the composite electrolyte (PHM-GPE) of Embodiment 1-3 had more excellent mechanical strength than the organic-inorganic composite porous membrane (PHM) of Embodiment 1-2.

### (3) Hardness

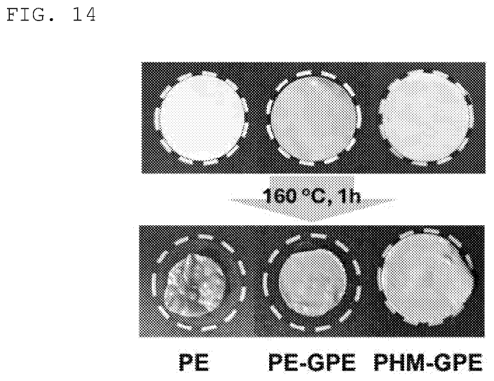

The hardness of the composite electrolyte obtained in Embodiment 1-3 was measured using a Nanoindenter (NanoTest Vantage Platform manufactured by MICRO MATERIALS), and the results are shown in FIG. 12.

The measurement results showed that both the organic-inorganic composite porous membrane (PHM) of Embodiment 1-2 and the composite electrolyte (PHM-GPE) of Embodiment 1-3 had higher hardness than a polyethylene separator (PE) and a polyethylene separator (PE-GPE) impregnated with a gel polymer electrolyte. In addition, the composite electrolyte (PHM-GPE) of Embodiment 1-3 had higher hardness than the organic-inorganic composite porous membrane (PHM) of Embodiment 1-2.

This confirms that the composite electrolyte of the present invention has excellent mechanical properties while maintaining a crystal structure of a metal oxide-based nano-particle.

### <Experimental Example 5>—Thermal Properties of Composite Electrolyte

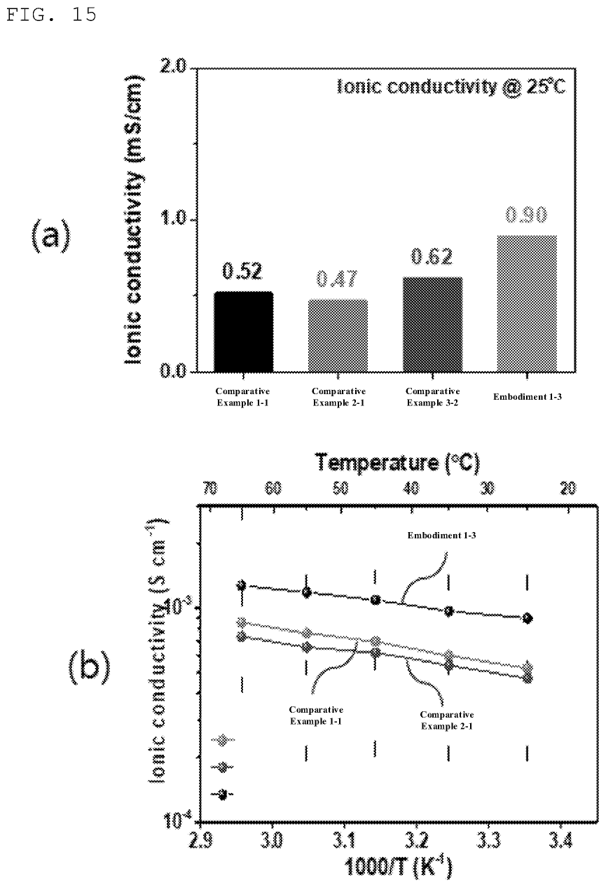

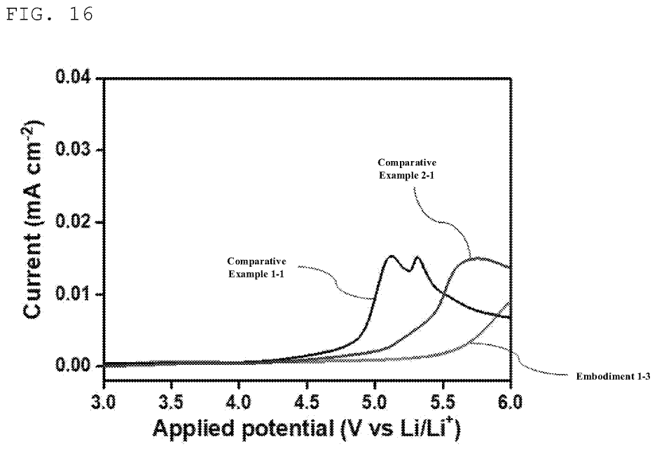

Thermal properties of the composite electrolyte of the present invention were measured as follows, and the results are shown in FIGS. 13 and 14.

### (1) Thermogravimetric Analysis (TGA)

A TGA analysis of the composite electrolyte obtained in Embodiment 1-3 was conducted using a thermal analyzer (SDT Q600; temperature range: 25 to 900° C., heating rate: 10° C./min, ambient: Air), and the results are shown in FIG. 13. As a control group, a polyethylene separator (PE-GPE) impregnated with a gel polymer electrolyte was used. The component of a GPE in the PE-GPE was identical to the component of the gel polymer electrolyte impregnated in Embodiment 1-3.

As illustrated in FIG. 13, the composite electrolyte of Embodiment 1-3 had more excellent thermal stability than the PE-GPE. This was presumed to be because the composite electrolyte of Embodiment 1-3 exhibited excellent thermal stability due to the presence of the LLZAO nano-fiber, which has superior thermal stability, unlike the PE-GPE.

(2) Evaluation of Appearance Changes after High-Temperature Storage

After the composite electrolyte obtained in Embodiment 1-3 was stored at a temperature of 160° C. for one hour, the change in appearance of the composite electrolyte was visually observed, and appearances before and after the high-temperature storage are shown in FIG. 14. As control groups, a polyethylene separator (PE) and a polyethylene separator (PE-GPE) impregnated with a gel polymer electrolyte were used. The component of a GPE in the PE-GPE was identical to the component of the gel polymer electrolyte impregnated in Embodiment 1-3.

### <Experimental Example 6>—Ionic Conductivity of Composite Electrolyte

The ionic conductivity of the composite electrolyte (Sample 1) manufactured in Embodiment 1-3 was measured as follows, and the results are shown in (a) and (b) of FIG. 15. As Control Sample 1, a polyethylene separator (thickness: 20 μm) impregnated with the liquid electrolyte of Comparative Example 1-1 was used; as Control Sample 2, a polyethylene separator (thickness: 20 μm) impregnated with the gel polymer electrolyte composition of Comparative Example 2-1 and then thermally cured was used; and as Control Sample 3, the composite electrolyte of Comparative Example 3-2 was used.

Each sample was placed in a coin-type battery case to manufacture a coin-type symmetric cell, an internal resistance (R) of the manufactured coin-type symmetric cell was measured through an AC-impedance method, and an ionic conductivity (0) was calculated through Equation 1 below. At this time, a CHI-660d was used as a measuring instrument.

$$σ = \frac{L}{R \times A} \qquad [ Equation 1 ]$$

(In the above equation,
L is a thickness of the sample (porous membrane),
R is an internal resistance of the cell, and
A is an effective area in which an electrode and the sample (porous membrane) contact each other.)
(a) of FIG. 15 is a graph illustrating ionic conductivity of each electrolyte at 25° C., and (b) of FIG. 15 is a graph illustrating ionic conductivity of each electrolyte by temperature.

As illustrated in (a) of FIG. 15, the composite electrolyte of Embodiment 1-3 and the composite electrolyte of Comparative Example 3-2 including an LLZAO component, which is a metal oxide, had significantly higher ionic conductivity than the liquid electrolyte of Comparative Example 1-1 and the gel polymer electrolyte of Comparative Example 2-1 not including an LLZAO component. In particular, the composite electrolyte of Embodiment 1-3 containing the LLZAO component in a form of a nano-fiber exhibited more excellent ionic conductivity than the composite electrolyte of Comparative Example 3-2 containing the LLZAO component in a powder form.

In addition, as illustrated in (b) of FIG. 15, the gel polymer electrolyte of Comparative Example 2-1 exhibited lower ionic conductivity than the liquid electrolyte of Comparative Example 1-1, whereas the composite electrolyte of Embodiment 1-3 exhibited higher ionic conductivity than the liquid electrolyte of Comparative Example 1-1.

### <Experimental Example 7>—Evaluation of Electrochemical Oxidation Stability of Composite Electrolyte

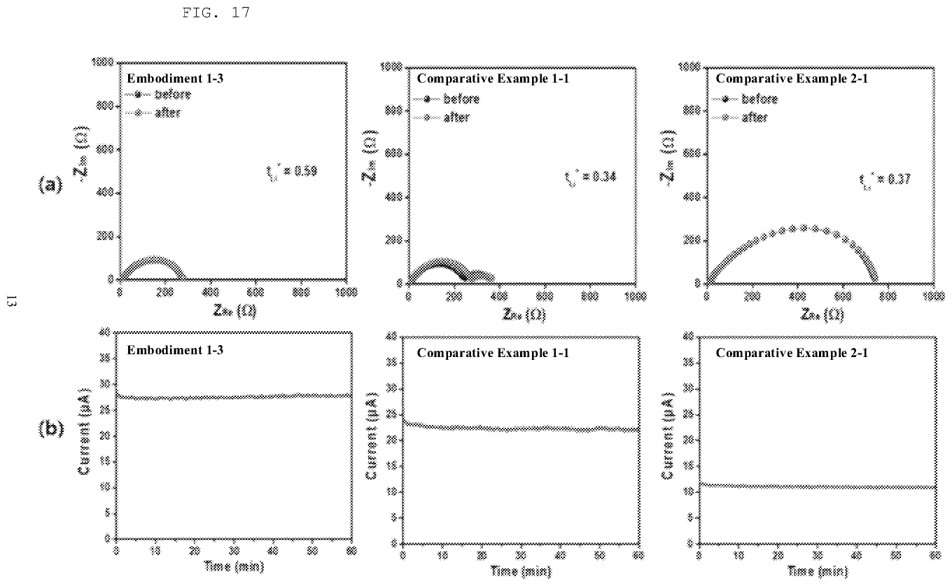

In order to evaluate electrochemical oxidation stability of the composite electrolyte manufactured in Embodiment 1-3, linear sweep voltammetry (LSV) was measured under the following experimental conditions, and the results are shown in FIG. 16. The liquid electrolyte of Comparative Example 1-1 was used as Control Group 1, while the gel polymer electrolyte of Comparative Example 2-1 was used as Control Group 2.

The LSV experiment was conducted at a scan rate of 1 mV/s at 25° C., and evaluated using SUS as the working electrode and lithium foil as both the reference and counter electrodes. The evaluation range was 3.0 V to 6.0 V (vs Li/Li⁺), and the change in current was observed while the voltage was continuously increased.

As illustrated in FIG. 16, the composite electrolyte of Embodiment 1-3 exhibited significantly superior oxidation stability compared with both the gel polymer electrolyte of Comparative Example 2-1 and the liquid electrolyte of Comparative Example 1-1.

### <Experimental Example 8>—Evaluation of Lithium-Ion Transference Number of Composite Electrolyte

To measure the lithium-ion transference number of the composite electrolyte obtained in Embodiment 1-3, AC impedance and potentiostatic measurements were performed, and the results are shown in (a) and (b) of FIG. 17. The voltage amplitude used for both the potentiostatic and AC impedance measurements was 10 mV. In addition, the results obtained in the two experiments were substituted into a Bruce-Vincent method to determine the lithium-ion transference number. Here, the liquid electrolyte of Comparative Example 1-1 was used as Control Group 1, while the gel polymer electrolyte of Comparative Example 2-1 was used as Control Group 2.

(a) of FIG. 17 is a graph showing the results of AC impedance measurements taken before and after application of a potentiostatic method to a lithium|lithium battery manufactured using each electrolyte, and (b) of FIG. 17 is a graph showing the results obtained when the potentiostatic method is applied with each electrolyte.

It could be confirmed that the composite electrolyte of Embodiment 1-3 had a significantly higher lithium-ion transference number than the liquid electrolyte of Comparative Example 1-1 and the gel polymer electrolyte of Comparative Example 2-1. This was presumed to be because the composite electrolyte of Embodiment 1-3 included the web of LLZAO nano-fibers.

### <Experimental Example 9>—Evaluation of Cycle Characteristics of Coin-Type Lithium-Ion Secondary Battery

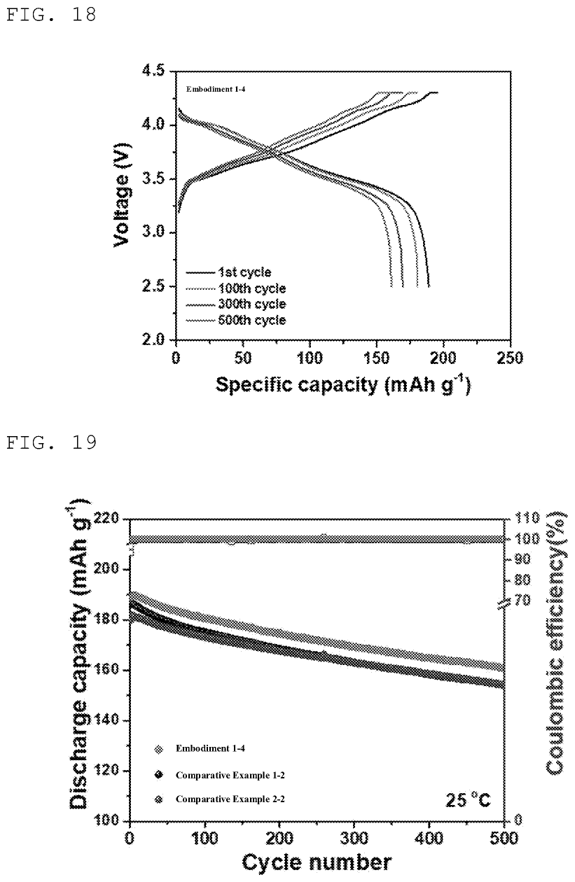

To evaluate the cycle characteristics of the coin-type lithium-ion secondary battery manufactured in Embodiment 1-4 at room temperature (about 25° C.) and a high temperature (55° C.), a repeated charge-discharge experiment of the lithium secondary battery was performed, and the results are shown in FIGS. 18 to 21, respectively. The charge-discharge rate was 0.1 C, and after two formation cycles, the evaluation results at 0.5 C are presented. Here, the coin-type lithium-ion secondary battery of Comparative Example 1-2 was used as Control Group 1, while the coin-type lithium-ion secondary battery of Comparative Example 2-2 was used as Control Group 2.

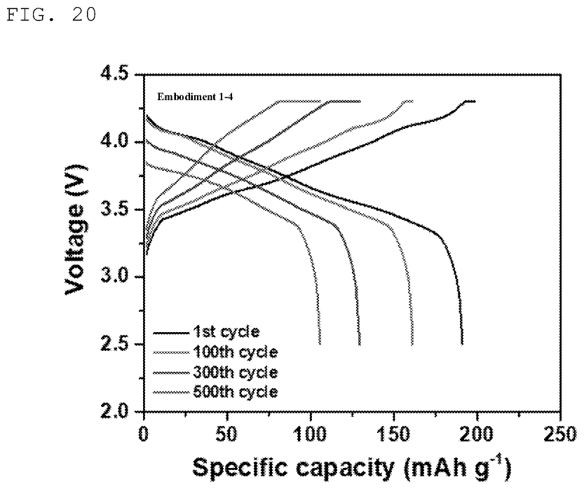

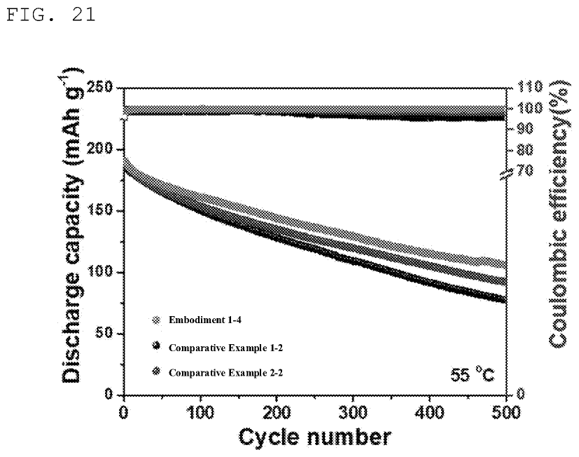

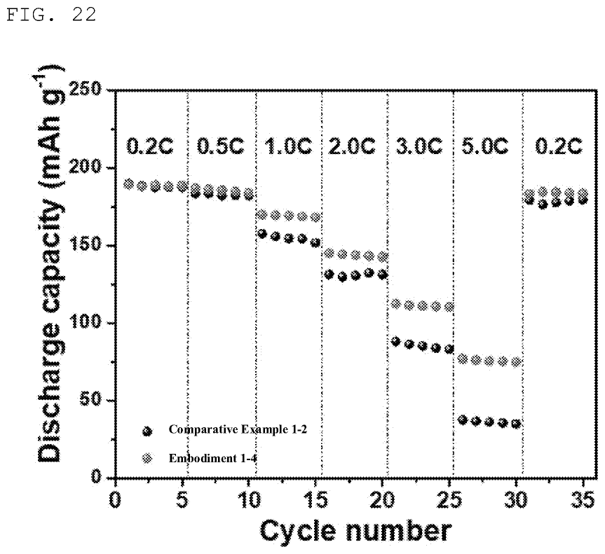

FIG. 18 illustrates the charge-discharge curve and the discharge capacity of the coin-type lithium-ion secondary battery of Embodiment 1-4 according to a cycle at room temperature (25° C.); FIG. 19 illustrates the discharge capacity of the coin-type lithium-ion secondary batteries of Embodiment 1-4, Comparative Example 1-2, and Comparative Example 2-2 according to a cycle at room temperature (25° C.); FIG. 20 illustrates the charge-discharge curve and the discharge capacity of the coin-type lithium-ion secondary battery of Embodiment 1-4 according to a cycle at a high temperature (about 55° C.); and FIG. 21 illustrates the discharge capacity of the coin-type lithium-ion secondary batteries of Embodiment 1-4, Comparative Example 1-2, and Comparative Example 2-2 according to a cycle at a high temperature (about 55° C.).

In the measurement results, the coin-type lithium-ion secondary battery of Comparative Example 2-2 to which the gel polymer electrolyte was applied had excellent lifespan characteristics, but a low initial capacity, compared to the coin-type lithium-ion secondary battery of Comparative Example 1-1 to which the liquid electrolyte was applied. In contrast, the coin-type lithium-ion secondary battery of Embodiment 1-4, to which the composite electrolyte was applied, exhibited superior cycle life and capacity compared with the coin-type lithium-ion secondary battery of Comparative Example 2-2, to which the gel polymer electrolyte was applied, and also showed improved lifespan characteristics.

### <Experimental Example 10>—Evaluation of Rate Characteristics of Coin-Type Lithium-Ion Secondary Battery

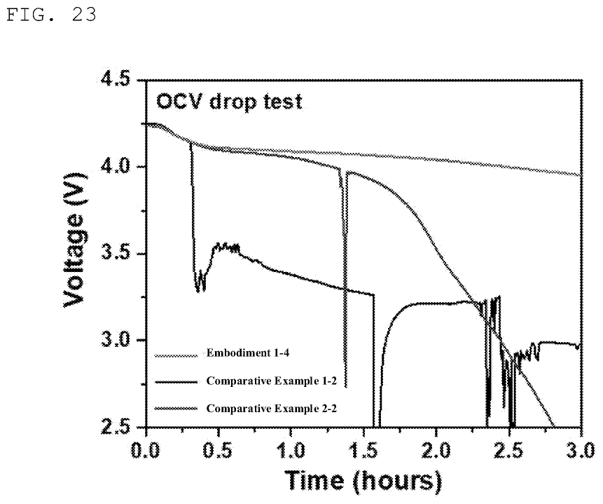

The change in discharge capacity as a function of rate for the coin-type lithium-ion secondary battery manufactured in Embodiment 1-4 was evaluated, and the results are shown in FIG. 22. The charge rate was fixed to 0.2 C, and a discharge rate was adjusted to 0.2 C-0.5 C-1.0 C-2.0 C-3.0 C-5.0 C-0.2 C to perform evaluation. As a control group, the coin-type lithium-ion secondary battery of Comparative Example 1-2 was used.

As illustrated in FIG. 22, the coin-type lithium-ion secondary battery of Embodiment 1-4, to which the composite electrolyte was applied, was confirmed to operate even at 0.5 C. In addition, the coin-type lithium-ion secondary battery of Embodiment 1-4 exhibited a higher discharge capacity than the coin-type lithium-ion secondary battery of Comparative Example 1-2, to which the liquid electrolyte was applied, attributable to its high ionic conductivity.

### <Experimental Example 11>—Evaluation of Ultra-High Temperature OCV of Coin-Type Lithium-Ion Secondary Battery

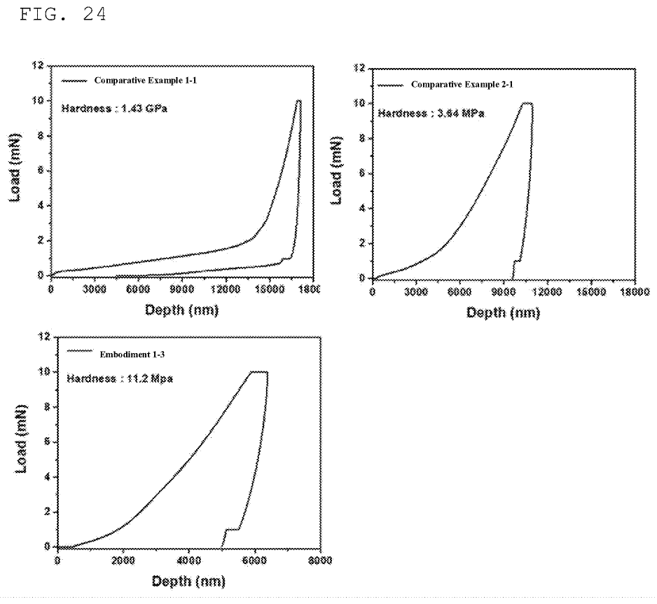

In order to evaluate an ultra-high temperature OCV change of the coin-type lithium-ion secondary battery manufactured in Embodiment 1-4, the coin-type lithium-ion secondary battery manufactured in Embodiment 1-4 was left at 140° C. in a charged state, and the open-circuit voltage was then measured. The measurement results are shown in FIG. 23. The coin-type lithium-ion secondary batteries of Comparative Examples 1-2 and 2-2 were respectively used as Control Groups 1 and 2.

As illustrated in FIG. 23, the battery of Comparative Example 1-2, to which the liquid electrolyte was applied, exhibited a rapid voltage drop, whereas the battery of Comparative Example 2-2, to which the gel polymer electrolyte was applied, showed a gradual decrease in voltage followed by a rapid drop after a certain period. In contrast, the battery of Embodiment 1-4 to which the composite electrolyte was applied had a gradual voltage decrease without a rapid voltage drop. Unlike the battery of Comparative Example 1-2 or the battery of Comparative Example 2-2, the battery of Embodiment 1-4 did not use a separate separator due to use of the composite electrolyte. Accordingly, shrinkage of the electrolyte and the separator does not occur, and short circuiting is effectively prevented.

### <Experimental Example 12>—Evaluation of Physical Properties of Composite Electrolyte

To evaluated the mechanical strength of the composite electrolyte manufactured in Embodiment 1-3, a nano-indentation test was performed with a fixed maximum applied force of 10 mN, and the results are shown in FIG. 24. A polyethylene separator (thickness: 20 μm) impregnated with the liquid electrolyte of Comparative Example 1-1 was used as Control Group 1, and a polyethylene separator (thickness: 20 μm) impregnated with the gel polymer electrolyte composition of Comparative Example 2-1 and then thermally cured was used as Control Group 2.

As illustrated in FIG. 24, the composite electrolyte of Embodiment 1-3 had more excellent mechanical strength than the liquid electrolyte of Comparative Example 1-1 and the gel polymer electrolyte of Comparative Example 2-1. From this, it was confirmed that the composite electrolyte of Embodiment 1-3 exhibits significantly higher rigidity than a conventional separator (PE separator) impregnated with a liquid electrolyte or a gel polymer electrolyte, even in the absence of a separate separator.

### <Experimental Example 13>—Lithium-Ion Migration Path of Composite Electrolyte

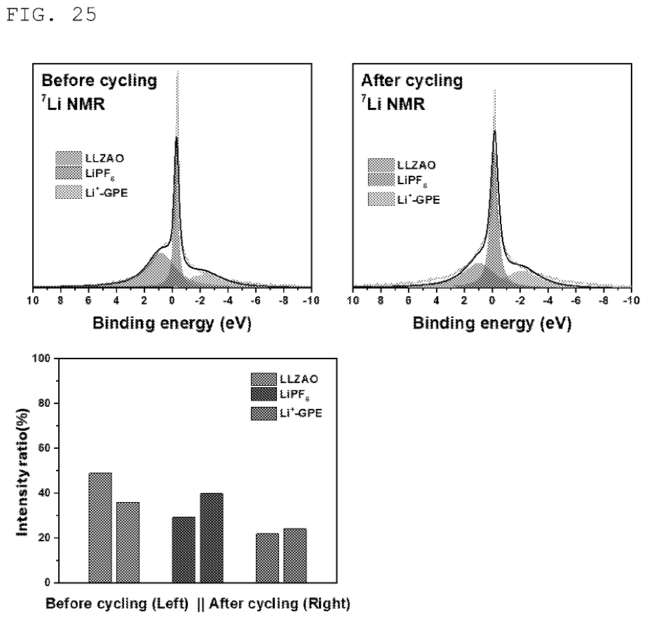

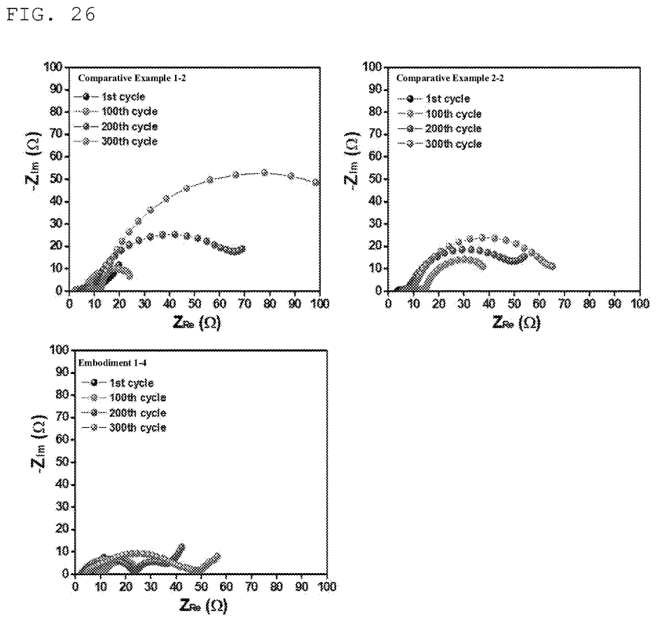

To examine the lithium-ion migration path of the composite electrolyte manufactured in Embodiment 1-3, analysis was performed through ⁷Li NMR, and the results are shown in FIG. 25. A battery was manufactured by respectively placing ⁶Li electrodes on both sides of the composite electrolyte manufactured in Embodiment 1-3. The battery was then subjected to 50 charge-discharge cycles for one hour each at a current density of 0.2 mA/cm², after which it was disassembled and the composite electrolyte was analyzed after cycling.

As an analysis result, the ⁷Li content of the web composed of the LLZAO nano-fiber in the composite electrolyte of Embodiment 1-3 significantly decreased, and it could be estimated that the web composed of the LLZAO nano-fiber was replaced with ⁶Li. This phenomenon could be interpreted as indicating that the LLZAO nanofibers in the composite electrolyte of Embodiment 1-3 significantly contribute to lithium-ion conductivity.

### <Experimental Example 14>—Change in Impedance with Progression of Cycles

To evaluate the change in internal resistance of the lithium-ion secondary battery of Embodiment 1-4 according to charge-discharge cycle progression at a high temperature, the battery was operated, and its internal resistance was measured at 100-cycle intervals. The lithium-ion secondary battery of Comparative Example 1-2 was used as Control Group 1, while the lithium-ion secondary battery of Comparative Example 2-2 was used as Control Group 2. The measurement results are shown in FIG. 26.

As a result of the measurement, the battery of Comparative Example 1-2, to which the liquid electrolyte was applied, exhibited the most rapid increase in internal resistance. The rate of increase in internal resistance decreased in the order of the battery of Comparative Example 2-2, to which the gel polymer electrolyte was applied, and the battery of Example 1-4, to which the composite electrolyte was applied.

From this, it was confirmed that the composite electrolyte of the present invention exhibits excellent electrochemical and chemical stability comparable to that of the gel polymer electrolyte, while also showing a lower internal resistance than the gel polymer electrolyte.

### <Experimental Example 15>—Ignition Test of Composite Electrolyte

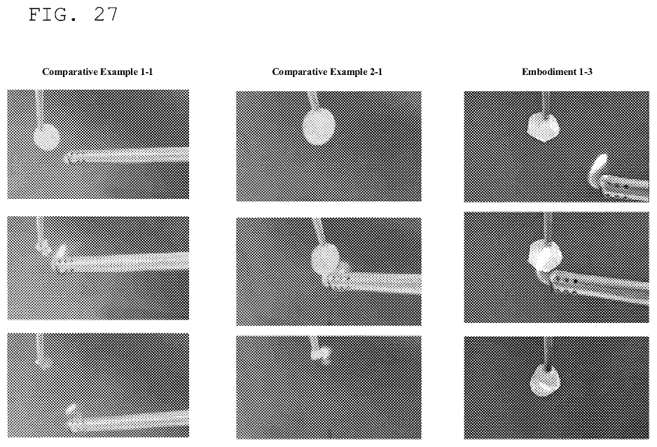

In order to confirm flame retardancy of the composite electrolyte manufactured in Embodiment 1-3, an ignition test was performed on the composite electrolyte of Embodiment 1-3. A polyethylene separator impregnated with the liquid electrolyte of Comparative Example 1-1 was used as Control Group 1, while a polyethylene separator impregnated with the gel polymer electrolyte of Comparative Example 2-1 and thermally cured was used as Control Group 2. The ignition test results are shown in FIG. 27.

As a result of the experiment, both the polyethylene separator impregnated with the liquid electrolyte of Comparative Example 1-1 and the polyethylene separator impregnated with the gel polymer electrolyte of Comparative Example 2-1 rapidly contracted upon thermal curing and subsequently ignited and burned. In contrast, the composite electrolyte of Embodiment 1-3 self-extinguished rapidly and exhibited minimal contraction.

It was thus confirmed that the composite electrolyte of the present invention exhibits excellent flame retardancy.

1. An organic-inorganic composite porous membrane for an electrolyte, comprising: a nano-fiber web containing a metal oxide-based nano-fiber; and a binder resin.

2. The organic-inorganic composite porous membrane of claim 1, wherein the nano-fiber web and the binder resin are included in a weight ratio of 50:50 to 95:5.

3. The organic-inorganic composite porous membrane of claim 1, wherein
the metal oxide-based nano-fiber has a thickness of 50 nm to 3 μm.

4. The organic-inorganic composite porous membrane of claim 1, wherein
the metal oxide-based nano-fiber includes at least one selected from the group consisting of a lithium-containing metal oxide and a non-lithium-containing metal oxide.

5. The organic-inorganic composite porous membrane of claim 1, wherein
the metal oxide-based nano-fiber includes at least one metal oxide selected from the group consisting of Li₇₋₃ₓLa₃Zr₂AlₓO₁₂ (0<x<0.5) (LLZAO), Li_{1+x+y}AlₓTi₂₋ₓSi_{y}P_{3-y}O₁₂ (0<x<2, 0≤y<3), BaTiO₃, Pb(Zr,Ti)O₃ (PZT), Pb₁₋ₓLaₓZr_{1-y}Ti_{y}O₃ (0≤x<1, 0≤y<1) (PLZT), PB(Mg₃Nb_{2/3})O₃PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ (0<x<2, 0<y<3), LiₓAl_{y}Ti_{z}(PO₄)₃ (0<x<2, 0<y<1, 0<z<3), Li_{1+x+y}(Al, Ga)ₓ(Ti, Ge)₂₋ₓSi_{y}P_{3-y}O₁₂ (0≤x≤1, 0≤y≤1), LiₓLa_{y}TiO₃ (0<x<2, 0<y<3), Li₂O, LiOH, Li₂CO₃, LiAlO₂, Li₂O—Al₂O₃—SiO₂—P₂O₅—TiO₂—GeO₂, and Li₃₊ₓLa₃M₂O₁₂ (where M is Te, Nb, or Zr, and 1≤x≤10).

6. The organic-inorganic composite porous membrane of claim 1, wherein
the binder resin includes at least one selected from the group consisting of polyvinylidene fluoride-hexafluoropropylene (PVDF-HFP), polyvinylidene fluoride (PVDF), polyvinyl alcohol (PVA), polymethyl methacrylate (PMMA), and polyacrylonitrile (PAN).

7. A composite electrolyte comprising: the organic-inorganic composite porous membrane for an electrolyte according to claim 1; and
a gel polymer electrolyte part impregnated
into the organic-inorganic composite porous membrane.

8. The composite electrolyte of claim 7, wherein
the organic-inorganic composite porous membrane and the gel polymer electrolyte part are included in a weight ratio of 50:50 to 80:20.

9. The composite electrolyte of claim 7, wherein
the gel polymer electrolyte part includes a polymer matrix; and an electrolyte solution impregnated into the polymer matrix and containing a non-aqueous solvent and a lithium salt.

10. (canceled)

11. A method for manufacturing a composite electrolyte, comprising the steps of:
forming a nano-fiber web containing a metal oxide-based nano-fiber;
forming a membrane-forming composition comprising the nano-fiber web, a binder resin, a first solvent, and a second solvent having a higher boiling point than the first solvent;
applying the membrane-forming composition onto a substrate and drying the composition to form a composition membrane;
immersing the formed composition membrane in an immersion solvent to remove the second solvent;
vacuum drying the composition membrane to form the organic-inorganic composite porous membrane;
impregnating a gel polymer electrolyte composition into the organic-inorganic composite porous membrane; and
heat-treating the organic-inorganic composite porous membrane impregnated with the gel polymer electrolyte composition.

12. The method of claim 11, wherein
the step of forming the nano-fiber web includes the steps of:
randomly arranging and accumulating composite nano-fibers to form a composite nano-fiber web while forming the composite nano-fibers containing the at least one metal salt and the polymer by electro-spinning a spinning composition including at least one metal salt precursor, a polymer, and a third solvent; and
removing the polymer from the composite nano-fiber web by sintering the composite nano-fiber web.

13. The method of claim 12, wherein
the at least one metal salt precursor is at least one selected from the group consisting of a lithium-containing precursor and a non-lithium-containing metal precursor.

14. The method of claim 12, wherein
the polymer is selected from the group consisting of polyvinylpyrrolidone, polyvinyl alcohol, polyacrylic acid, polymethacrylic acid, polyethylene oxide, polyvinyl acetate, and polyacrylonitrile.

15. The method of claim 12, wherein
the spinning composition comprises the at least one metal salt precursor and the polymer in a weight ratio of 1:1 to 5:1.

16. The method of claim 12, wherein
the electro-spinning is performed under the following conditions (i) to (iii):
(i) an applied voltage is in a range of 10 to 20 kV;
(ii) a spinning flow rate of the spinning composition is in a range of 0.1 to 1 ml/hr; and
(iii) a Tip to Collector Distance (TCD) is in a range of 10 to 30 cm.

17. The method of claim 12, wherein the step of sintering is performed by heat-treating at a temperature of 700 to 800° C. for five to seven hours.

18. The method of claim 11, wherein
the gel polymer electrolyte composition comprises an electrolyte solution containing a non-aqueous solvent and a lithium salt, a polymerizable monomer, and a polymerization initiator.

19. The method of claim 18, wherein
the polymerizable monomer comprises a polymerizable monomer containing two or more (meth)acrylate groups.

20. The method of claim 11, wherein
the step of heat-treating is performed at a temperature of 60 to 80° C. for one to three hours.
